(19) United States
(12) Patent Application Publication
(10) Pub. No.: US 2009/0077508 A1
(43) Pub. Date: Mar. 19, 2009

(54) ACCELERATED LIFE TESTING OF SEMICONDUCTOR CHIPS

(76) Inventors: Daniel I. Rubin, Atherton, CA (US); Rajit Chandra, Cupertino, CA (US); Earl T. Cohen, Oakland, CA (US)

Correspondence Address: WALSTEIN BENNETT SMITH III, P. O. BOX 1668, GEORGETOWN, TX, 78628, US

(21) Appl. No.: 12/193,752

(22) Filed: Aug. 19, 2008

Related U.S. Application Data
(63) Continuation-in-part of application No. 11/680,385, filed on Feb. 28, 2007.
Application No. 11/680,385 is a continuation-in-part of application No. 12/016,467, filed on Jan. 18, 2008.
Application No. 12/016,467 is a continuation-in-part of application No. 12/046,240, filed on Mar. 11, 2008.
Application No. 12/046,240 is a continuation-in-part of application No. 12/140,188, filed on Jun. 16, 2008.
Application No. 12/140,188 is a continuation of application No. PCT/US06/62184, filed on Dec. 15, 2006.
Application No. PCT/US06/62184 is a continuation of application No. 11/317,668, filed on Dec. 23, 2005, now Pat. No. 7,472,363.
Application No. 11/317,668 is a continuation of application No. 11/317,670, filed on Dec. 23, 2005.
Application No. 11/317,670 is a continuation of application No. 11/317,664, filed on Dec. 23, 2005.
Application No. 11/317,664 is a continuation-in-part of application No. 11/180,353, filed on Jul. 13, 2005, now Pat. No. 7,401,304.
Application No. 11/180,353 is a continuation-in-part of application No. 10/979,957, filed on Nov. 3, 2004, now Pat. No. 7,194,711.
Application No. 10/979,957 is a continuation-in-part of application No. 11/039,737, filed on Jan. 20, 2005, now Pat. No. 7,203,920.
Application No. 11/317,670 is a continuation-in-part of application No. 11/198,467, filed on Aug. 5, 2005, now Pat. No. 7,383,520.
Application No. 11/198,467 is a continuation-in-part of application No. 10/979,957, filed on Nov. 3, 2004, now Pat. No. 7,194,711.
Application No. 11/317,670 is a continuation-in-part of application No. 11/198,470, filed on Aug. 5, 2005, now Pat. No. 7,353,471.
Application No. 11/198,470 is a continuation-in-part of application No. 10/979,957, filed on Nov. 3, 2004, now Pat. No. 7,194,711.
Application No. 11/317,670 is a continuation-in-part of application No. 11/215,783, filed on Aug. 29, 2005, now Pat. No. 7,458,052.
Application No. 11/215,783 is a continuation-in-part of application No. 10/979,957, filed on Nov. 3, 2004, now Pat. No. 7,194,711.
Application No. 10/979,957 is a continuation-in-part of application No. 11/078,047, filed on Mar. 11, 2005, now Pat. No. 7,191,413.
Application No. 11/078,047 is a continuation-in-part of application No. 10/979,957, filed on Nov. 3, 2004, now Pat. No. 7,194,711.
Application No. 10/979,957 is a continuation-in-part of application No. 11/039,737, filed on Jan. 20, 2005, now Pat. No. 7,203,920.
Application No. 11/039,737 is a continuation-in-part of application No. 10/979,957, filed on Nov. 3, 2004, now Pat. No. 7,194,711.
Application No. 11/317,670 is a continuation-in-part of application No. 10/979,957, filed on Nov. 3, 2004, now Pat. No. 7,194,711.
Application No. 11/680,385 is a continuation of application No. 11/039,737, filed on Jan. 20, 2005, now Pat. No. 7,203,920.
Application No. 11/039,737 is a continuation-in-part of application No. 10/979,957, filed on Nov. 3, 2004, now Pat. No. 7,194,711.
Application No. 12/016,467 is a continuation of application No. 11/198,470, filed on Aug. 5, 2005, now Pat. No. 7,353,471.
Application No. 11/198,470 is a continuation-in-part of application No. 10/979,957, filed on Nov. 3, 2004, now Pat. No. 7,194,711.
Application No. 12/046,240 is a continuation of application No. 11/198,467, filed on Aug. 5, 2005, now Pat. No. 7,383,520.
Application No. 11/198,467 is a continuation-in-part of application No. 10/979,957, filed on Nov. 3, 2004, now Pat. No. 7,194,711.
(60) Provisional application No. 60/956,710, filed on Aug. 19, 2007.
(60) Provisional application No. 60/744,405, filed on Apr. 6, 2006.
(60) Provisional application No. 60/751,376, filed on Dec. 17, 2005.
(60) Provisional application No. 60/751,376, filed on Dec. 17, 2005.
(60) Provisional application No. 60/734,372, filed on Nov. 7, 2005.
(60) Provisional application No. 60/718,138, filed on Sep. 16, 2005.
(60) Provisional application No. 60/587,313, filed on Jul. 13, 2004.
(60) Provisional application No. 60/599,098, filed on Aug. 5, 2004.
(60) Provisional application No. 60/599,278, filed on Aug. 5, 2004.
(60) Provisional application No. 60/598,987, filed on Aug. 5, 2004.
(60) Provisional application No. 60/605,889, filed on Aug. 30, 2004.
(60) Provisional application No. 60/689,592, filed on Jun. 10, 2005.
(60) Provisional application No. 60/552,375, filed on Mar. 11, 2004.
(60) Provisional application No. 60/658,323, filed on Mar. 3, 2005.
(60) Provisional application No. 60/658,324, filed on Mar. 3, 2005.
(60) Provisional application No. 60/539,727, filed on Jan. 28, 2004.
(60) Provisional application No. 60/599,098, filed on Aug. 5, 2004.
(60) Provisional application No. 60/539,727, filed on Jan. 28, 2004.
(60) Provisional application No. 60/599,098, filed on Aug. 5, 2004.
(60) Provisional application No. 60/539,727, filed on Jan. 28, 2004.
(60) Provisional application No. 60/598,987, filed on Aug. 5, 2004.
(60) Provisional application No. 60/599,278, filed on Aug. 5, 2004.

(51) Int. Cl. G06F 17/50

(52) U.S. Cl. 716/4

(57) ABSTRACT

Improved techniques for accelerated life testing of a sample of semiconductor chips advantageously enable more effective testing and better estimation of lifetime. Full-chip temperature maps are computed at sets of operating and testing conditions. Evaluating the temperature maps enables operations such as: temperature-aware design changes, including adding and/or configuring heating elements, cooling elements, thermal diodes, or sensors; determination of accelerated testing conditions; avoidance of harmful conditions during accelerated testing; and the better estimation of lifetime. Iteration of the computing and the evaluating refines the accelerated testing conditions. Measuring actual testing conditions and computing a full-chip temperature map using the actual testing conditions enables the estimation of lifetime to account for the actual testing conditions. A lifetime acceleration factor map based, at least in part, on the temperature maps is used to produce the estimated lifetime. Failure analysis improves accuracy of the estimated lifetime.

### CROSS REFERENCE TO RELATED APPLICATIONS

Priority benefit claims for this application are made in the accompanying Application Data Sheet, Request, or Transmittal (as appropriate, if any). To the extent permitted by the type of the instant application, this application incorporates by reference for all purposes the following applications, all owned by the owner of the instant application:
U.S. application Ser. No. 12/137,344 (Docket No. GRAD/006CON) filed Jun. 11, 2008, first named inventor Ping Li, and entitled Method and Apparatus for Thermal Modeling and Analysis of Semiconductor Chip Designs;
U.S. application Ser. No. 12/140,188 (Docket No. GDA-2007-10US), filed Jun. 2, 2008, first named inventor Rajit Chandra, and entitled Thermally Aware Design Modification;
U.S. application Ser. No. 12/131,821 (Docket No. GDA-2007-02NP), filed Jun. 2, 2008, first named inventor Rajit Chandra, and entitled Thermal Simulation Using Adaptive 3D and Hierarchical Grid Mechanisms;
U.S. application Ser. No. 12/101,983 (Docket No. GDA-2007-01NP), filed Apr. 12, 2008, first named inventor Rajit Chandra, and entitled Transient Thermal Analysis.
U.S. application Ser. No. 12/046,240 (Docket No. GRAD/009C) filed Mar. 11, 2008, first named inventor Rajit Chandra, and entitled Method and Apparatus for Optimizing Thermal Management System Performance Using Full-Chip Thermal Analysis of Semiconductor Chip Designs;
U.S. application Ser. No. 12/016,467 (Docket No. GRAD/010CON) filed Jan. 18, 2008, first named inventor Rajit Chandra, and entitled Method and Apparatus for Using Full-Chip Thermal Analysis of Semiconductor Chip Designs to Compute Thermal Conductance;
U.S. Provisional Application Ser. No. 60/956,710 (Docket No. GDA-2007-03), filed Aug. 19, 2007, first named inventor Daniel Rubin, and entitled Accelerated Life Testing Of Semiconductor Chips;
U.S. Provisional Application Ser. No. 60/941,660 (Docket No. GDA-2007-02), filed Jun. 2, 2007, first named inventor Rajit Chandra, and entitled Simulation of IC Temperature Distributions Using a Hierarchical Grid;
U.S. Provisional Application Ser. No. 60/917,185 (Docket No. GDA-2007-01B), filed May 10, 2007, first named inventor Rajit Chandra, and entitled Transient Thermal Analysis;
U.S. Provisional Application Ser. No. 60/911,516 (Docket No. GDA_{—}2007_{—}01), filed Apr. 12, 2007, first named inventor Rajit Chandra, and entitled Transient Thermal Analysis;
U.S. application Ser. No. 11/039,737 (Docket No. GRAD/007CON) filed Feb. 28, 2007, first named inventor Rajit Chandra, and entitled Method and Apparatus for Retrofitting Semiconductor Chip Performance Analysis Tools with Full-Chip Thermal Analysis Capabilities;
U.S. application Ser. No. 11/668,370 (Docket No. GRAD/012CON) filed Jan. 29, 2007, first named inventor Rajit Chandra, and entitled Method and Apparatus for Full-Chip Thermal Analysis of Semiconductor Chip Designs;
PCT Application Serial No. PCT/US06/62184 (Docket No. GDA_{—}06_{—}10PCT) filed Dec. 15, 2006, first named inventor Rajit Chandra, entitled Simulation of IC Temperature Distributions Using an Adaptive 3D Grid;
International Patent Application Serial No. PCT/US06/30940 (Docket No. GRAD/009PCT) filed Aug. 4, 2006, first named inventor Rajit Chandra, and entitled Method and Apparatus for Optimizing Thermal Management Systems Performance Using Full-Chip Thermal Analysis of Semiconductor Chip Designs;
U.S. Provisional Application Ser. No. 60/744,405 (Docket No. GDA.2006.01) filed Apr. 4, 2006, first named inventor Rajit Chandra, and entitled Simulation of IC Temperature Distributions Using an Adaptive 3D Grid Based on Design Variables and Material Characteristics;
U.S. application Ser. No. 11/317,668 (Docket No. GDA.2005.23NP) filed Dec. 23, 2005, first named inventor Rajit Chandra, and entitled Semiconductor Chip Design Having Thermal Awareness Across Multiple Sub-System Domains;
U.S. application Ser. No. 11/317,664 (Docket No. GDA.2005.08NP) filed Dec. 23, 2005, first named inventor Rajit Chandra, and entitled Method and Apparatus for Thermally Aware Design Improvement;
U.S. application Ser. No. 11/317,670 (Docket No. GDA.2005.09NP) filed Dec. 23, 2005, first named inventor Rajit Chandra, and entitled Method and Apparatus for Generating and Using Thermal Test Vectors;
U.S. Provisional Application Ser. No. 60/751,376 (Docket No. GDA.2005.23) filed Dec. 17, 2005, first named inventor Rajit Chandra, and entitled Semiconductor Chip Design Having Thermal Awareness Across Multiple Sub-System Domains;
U.S. Provisional Application Ser. No. 60/734,372 (Docket No. GDA.2005.24) filed Nov. 7, 2005, first named inventor Rajit Chandra, and entitled Efficient Full-Chip Thermal Modeling and Analysis;
U.S. Provisional Application Ser. No. 60/718,138 (Docket No. GDA.2005.22) filed Sep. 16, 2005, first named inventor Rajit Chandra, and entitled Method and Apparatus for Temperature Assertion Based IC Design;
U.S. application Ser. No. 11/215,783 (Docket No. GRAD/011) filed Aug. 29, 2005, first named inventor Rajit Chandra, and entitled Method and Apparatus for Normalizing Thermal Gradients Over Semiconductor Chip Designs;
U.S. application Ser. No. 11/198,470 (Docket No. GRAD/010) filed Aug. 5, 2005, first named inventor Rajit Chandra, and entitled Method and Apparatus for Using Full-Chip Thermal Analysis of Semiconductor Chip Designs to Compute Thermal Conductance;
U.S. application Ser. No. 11/198,467 (Docket No. GRAD/009) filed Aug. 5, 2005, first named inventor Rajit Chandra, and entitled Method and Apparatus for Optimizing Thermal Management System Performance Using Full-Chip Thermal Analysis of Semiconductor Chip Designs;
U.S. application Ser. No. 11/180,353 (Docket No. GRAD/006) filed Jul. 13, 2005, first named inventor Ping Li, and entitled Method and Apparatus for Thermal Modeling and Analysis of Semiconductor Chip Designs;
U.S. Provisional Application Ser. No. 60/689,592 (Docket No. GDA.2005.20) filed Jun. 10, 2005, first named inventor Rajit Chandra, and entitled Temperature-Aware Design Methodology;
U.S. application Ser. No. 11/078,047 (Docket No. GRAD/003) filed Mar. 11, 2005, first named inventor Rajit Chandra, and entitled Method and Apparatus for Thermal Testing of Semiconductor Chip Designs;
U.S. Provisional Application Ser. No. 60/658,323 (Docket No. GDA.2005.09) filed Mar. 3, 2005, first named inventor Rajit Chandra, and entitled Method and Apparatus for Generating and Using Thermal Test Vectors;
U.S. Provisional Application Ser. No. 60/658,324 (Docket No. GDA.2005.08) filed Mar. 3, 2005, first named inventor Rajit Chandra, and entitled Method and Apparatus for Thermally Aware Design Improvement;
U.S. application Ser. No. 11/039,737 (Docket No. GRAD/007) filed Jan. 20, 2005, first named inventor Rajit Chandra, and entitled Method and Apparatus for Retrofitting Semiconductor Chip Performance Analysis Tools with Full-Chip Thermal Analysis Capabilities;
U.S. application Ser. No. 10/979,957 (Docket No. GRAD/012) filed Nov. 3, 2004, first named inventor Rajit Chandra, and entitled Method and Apparatus for Full-Chip Thermal Analysis of Semiconductor Chip Designs;
U.S. Application Ser. No. 60/605,889 (Docket No. GRAD/011L) filed Aug. 30, 2004, first named inventor Rajit Chandra, and entitled Method and Apparatus for Normalizing On-Chip Temperature Gradients Using Distributed Power Sources;
U.S. Application Ser. No. 60/599,278 (Docket No. GRAD/009L) filed Aug. 5, 2004, first named inventor Rajit Chandra, and entitled Method and Apparatus for Using Full Chip Temperature Estimation Software to Efficiently Design and Control Cooling Systems;
U.S. Application Ser. No. 60/598,987 (Docket No. GRAD/010L) filed Aug. 5, 2004, first named inventor Rajit Chandra, and entitled Method and Apparatus for Using Thermal Layers to Efficiently Compute the Thermal Conductance in Semiconductor Designs;
U.S. Application Ser. No. 60/599,098 (Docket No. GRAD/007L) filed Aug. 5, 2004, first named inventor Rajit Chandra, and entitled Method and Apparatus for Retrofitting Commercial Timing, Delay, Voltage and Power Analysis Tools with Temperature Gradients;
U.S. Application Ser. No. 60/587,313 (Docket No. GRAD/006L) filed Jul. 13, 2004, first named inventor Ping Li, and entitled Efficient Full-Chip Thermal Modeling and Analysis;
U.S. Application Ser. No. 60/552,375 (Docket No. GRAD/003L) filed Mar. 11, 2004, first named inventor Rajit Chandra, and entitled Method and Apparatus for Insertion of Test Structures in Integrated Circuit Designs Using Temperature Gradient Data;
U.S. Application Ser. No. 60/539,727 (Docket No. GRAD/002L) filed Jan. 28, 2004, first named inventor Rajit Chandra, and entitled Method and Apparatus for Improving Constant Temperature Based Timing Analysis of Integrated Circuits by Using Computed Thermal Gradients.

### BACKGROUND

1. Field

Advancements in semiconductor chip design and testing are needed to provide improvements in performance, efficiency, accuracy, and utility of use.

2. Related Art

Unless expressly identified as being publicly or well known, mention herein of techniques and concepts, including for context, definitions, or comparison purposes, should not be construed as an admission that such techniques and concepts are previously publicly known or otherwise part of the prior art. All references cited herein (if any), including patents, patent applications, and publications, are hereby incorporated by reference, to the extent permitted by the type of the instant application, in their entireties, whether specifically incorporated or not, for all purposes.

### OVERVIEW

The invention may be implemented in numerous ways, including as a process, an article of manufacture, an apparatus, a system, and a computer readable medium (e.g. media in an optical and/or magnetic mass storage device such as a disk, or an integrated circuit having non-volatile storage such as flash storage). In this specification, these implementations, or any other form that the invention may take, may be referred to as techniques. The Detailed Description provides an exposition of one or more embodiments of the invention that enable improvements in performance, efficiency, and utility of use in the field identified above. The Detailed Description includes an Introduction to facilitate the more rapid understanding of the remainder of the Detailed Description. The Introduction includes Example Embodiments of one or more of systems, methods, articles of manufacture, and computer readable media in accordance with the concepts described herein. As is discussed in more detail in the Conclusions, the invention encompasses all possible modifications and variations within the scope of the issued claims.

### BRIEF DESCRIPTION OF DRAWINGS

FIG. 1 is a flow diagram illustrating selected details of an embodiment of estimating semiconductor chip lifetimes.

FIGS. 2A and 2B illustrate example temperature maps.

FIG. 2C illustrates an example differential temperature map.

FIGS. 3A and 3B illustrate selected details of a grid of a lifetime acceleration factor map.

### DETAILED DESCRIPTION

A detailed description of one or more embodiments of the invention is provided below along with accompanying figures illustrating selected details of the invention. The invention is described in connection with the embodiments. The embodiments herein are understood to be merely exemplary, the invention is expressly not limited to or by any or all of the embodiments herein, and the invention encompasses numerous alternatives, modifications and equivalents. To avoid monotony in the exposition, a variety of word labels (including but not limited to: first, last, certain, various, further, other, particular, select, some, and notable) may be applied to separate sets of embodiments; as used herein such labels are expressly not meant to convey quality, or any form of preference or prejudice, but merely to conveniently distinguish among the separate sets. The order of some operations of disclosed processes is alterable within the scope of the invention. Wherever multiple embodiments serve to describe variations in process, method, and/or program instruction features, other embodiments are contemplated that in accordance with a predetermined or a dynamically determined criterion perform static and/or dynamic selection of one of a plurality of modes of operation corresponding respectively to a plurality of the multiple embodiments. Numerous specific details are set forth in the following description to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Introduction

This introduction is included only to facilitate the more rapid understanding of the Detailed Description; the invention is not limited to the concepts presented in the introduction (including explicit examples, if any), as the paragraphs of any introduction are necessarily an abridged view of the entire subject and are not meant to be an exhaustive or restrictive description. For example, the introduction that follows provides overview information limited by space and organization to only certain embodiments. There are many other embodiments, including those to which claims will ultimately be drawn, discussed throughout the balance of the specification.

### Acronyms

Elsewhere herein various shorthand abbreviations, or acronyms, are used to refer to certain elements. The descriptions of at least some of the acronyms follow.

| Acronym | Description |
|---|---|
| DT | Differential Temperature |
| MEMS | Micro-Electro-Mechanical Systems |
| MTF | Mean Time to Failure |
| RMS | Root Mean Square |

### Accelerated Life Testing

In some usage scenarios, a semiconductor chip design is specified via a specification, such as via a netlist, and a plurality of semiconductor chips are built according to the specification. The semiconductor chips are said to embody the semiconductor chip design. In some usage scenarios, the specification includes information pertaining to one or more of: electrical construction of the semiconductor chip; mechanical information related to the semiconductor chip and/or packaging of the semiconductor chip; packaging of the semiconductor chip; a heatsink and/or a heat slug used with the semiconductor chip; environmental conditions of use of the semiconductor chip; and thermal properties of the semiconductor chip and/or of packaging of the semiconductor chip. In some usage scenarios, the specification is in accordance with one or more of various descriptions, such as hardware description languages, circuit descriptions, netlist descriptions, mask descriptions, layout descriptions, packaging descriptions, heatsink descriptions, mechanical descriptions, or thermal descriptions. Example descriptions include: Verilog, VHDL, SPICE, SPICE variants such as PSpice, IBIS, LEF, DEF, GDS-II, OASIS, or other descriptions.

In some embodiments, accelerated life testing is used as part of a flow to estimate lifetime of semiconductor chips embodying a semiconductor chip design. The semiconductor chips are designed and/or manufactured to operate at a normal operating set of conditions. For example, the semiconductor chips are designed to operate at a maximum (worst case in normal operation) temperature of 110 degrees C. for five years. A sample of the semiconductor chips, such as 100 of the semiconductor chips, is tested for a fixed duration, such 31 as 1000 hours, under an accelerated testing set of conditions that are more stressful than the normal operating set of conditions. For example, the accelerated testing set of conditions uses an ambient temperature of 150 degrees C. An estimated lifetime of the semiconductor chips is determined, at least in part, from a number of the semiconductor chips of the sample that fail during, or are observed to be failed after, the accelerated testing. The semiconductor chips optionally fail due to one or more failure mechanisms, such as electromigration. While electromigration is used as an example herein, the techniques described are applicable to various types of failure mechanisms, such as one or more of thermal stress, mechanical stress, exceeding temperature limits (meltdown), changes in transistor thresholds and/or changes in temperature sensitivity of the thresholds, charge accumulation, material breakdown, electromigration, and other time and/or temperature-related failure mechanisms.

In some usage scenarios, a Mean Time to Failure (MTF) of a semiconductor chip is determined by Black's equation:

MTF=A*J⁻ⁿ*e^{Ea/(k*T)}

where:
A is a constant dependent on one or more physical properties of the semiconductor chip (such as volume resistivity of metal, electron mean free path and average velocity, effective ion scattering cross section for electrons, and other physical properties), and is optionally determined experimentally;
Ea is activation energy in electron Volts (eV);
k is Boltzmann's constant, approximately 8.62*10⁻⁵ eV/° K.;
T is (average) temperature of the semiconductor chip in ° K.;
n is a current constant, and is optionally and/or selectively determined experimentally and/or based on physical properties of the semiconductor chip; and
J is a current density (which is, according to various embodiments, an average, a maximum, or an RMS quantity).
   Black's equation maps directly to an Arrhenius life-stress model, which assumes that lifetime of the semiconductor chip is proportional to the reaction rate (R), defined as

R=A*e^{Ea/(k*T)}

Black's equation shows that the mean time to failure is exponentially dependent on temperature. Experiments by d'Heurle reported in:
F. M. d'Heurle, “Electromigration and Failure in Electronics: An Introduction,” Proc. IEEE, Vol. 59, No. 10, 1409-1418, October 1971, which is hereby incorporated by reference, to the extent permitted by the type of the instant application, in its entirety, show that electromigration is accelerated in the presence of thermal gradients in wires. In some usage scenarios, a value of n in Black's equation is approximately 2 in a case of uniform temperature, but is a larger value, approximately 3, if thermal gradients are present. According to d'Heurle's paper, the larger value of n is attributed to thermomigration (also called the Sorret effect).

In some usage scenarios, a lifetime acceleration factor (Lc) specifies an estimated factor by which lifetime is decreased due to operation at the accelerated testing set of conditions, and is specified as a ratio of the mean time to failures between the normal operating set of conditions and the accelerated testing set of conditions:

Lc=(Anormal/Aaccel)*(Jnormal/Jaccel)⁻ⁿ*e^{[Ea/(k*Tnormal)-Ea/(k*Taccel)]}

where the variables are as above for Black's equation, annotated for the normal operating set of conditions (“normal”) and the accelerated testing set of conditions (“accel”).

In some usage scenarios, the estimated lifetime of the semiconductor chips is determined, at least in part, from the lifetime acceleration factor and from the number of the semiconductor chips of the sample that fail during, or are observed to be failed after, the accelerated testing. In a first example, 100 semiconductor chips are tested for 1000 hours at accelerated testing conditions having a lifetime acceleration factor of 1000 (compared to a normal operating set of conditions), and none of the semiconductor chips fail. The accelerated testing implies a failure rate of less than one semiconductor chip in 10⁸ hours of semiconductor chip operation at the normal operating set of conditions. In a second example, 1000 semiconductor chips are tested for 1000 hours at accelerated testing conditions having a lifetime acceleration factor of 100 (compared to a normal operating set of conditions), and one of the semiconductor chips fails. The failure is assumed to be one sample point of a statistical distribution of failures, such as a Weibull distribution, and statistical techniques are used to determine a mean time to failure of the semiconductor chips at the normal operating set of conditions. The statistical techniques are able to provide other statistics, such as mean lifetime, failure rate, reliability over time, and confidence bounds on accuracy of the statistics.

### Temperature Maps and Thermal Gradients

In some embodiments, temperature is an exponential factor in the mean time to failure (or equivalently, in the lifetime acceleration factor). Accordingly, a use of an average value for Tnormal and/or Taccel possibly results in over-estimation or under-estimation of the lifetime acceleration factor. In various embodiments, accurate determination of the lifetime acceleration factor is enabled by computation of a full-chip thermal analysis of the semiconductor chip design at the normal operating set of conditions and/or at the accelerated testing set of conditions. In some embodiments, the full-chip thermal analysis is computed at conditions substantially the same as conditions present during accelerated testing, some variation between simulated conditions of the full-chip thermal analysis and an actual testing environment being either necessary and/or acceptable. In further embodiments, some or all conditions present during accelerated testing are measured to determine actual values of the conditions, and a full-chip thermal analysis is computed at a set of conditions including the measured conditions. For example, a thermal diode is added to a semiconductor chip and/or to packaging of the semiconductor chip to measure an ambient temperature, and the full-chip thermal analysis uses the measured ambient temperature.

The full-chip thermal analysis produces a temperature map of the semiconductor chip design enabling a more accurate determination of temperatures within semiconductor chips embodying the semiconductor chip design. In some embodiments, the full-chip thermal analysis includes packaging and/or other environmental aspects of the semiconductor chip design. In some embodiments, the full-chip thermal analysis is a transient analysis, and accounts for dynamic operation of the semiconductor chip design, such as a portion of the semiconductor chip design having a duty cycle and/or a frequency of use. Descriptions herein refer to the semiconductor chip design, and in some embodiments the semiconductor chip design includes packaging, heatsinks, and other components associated and/or used with a semiconductor chip. For example, in some embodiments, the semiconductor chip design includes design of packaging of semiconductor chips embodying the semiconductor chip design, and the full-chip thermal analysis includes mechanical information, thermal properties, and/or temperature information of the packaging.

According to various embodiments, the full-chip thermal analysis is computed via various algorithms. One algorithm for full-chip thermal analysis is described in:
“3-D Thermal-ADI: A Linear-Time Chip Level Transient Thermal Simulator”, Ting-Yuan Wang, et al, IEEE Transactions On Computer-Aided Design Of Integrated Circuits And Systems, Vol. 21, No. 12, December, 2002, pg. 1434-1445,
   which is hereby incorporated by reference, to the extent permitted by the type of the instant application, in its entirety. Other algorithms for full-chip thermal analysis are described in:
U.S. Patent Publication No. US 2006/0031794 (Docket No. GRAD/006), published Feb. 9, 2006, first named inventor Peng Li, and entitled METHOD AND APPARATUS FOR THERMAL MODELING AND ANALYSIS OF SEMICONDUCTOR CHIP DESIGNS,
U.S. Pat. No. 7,194,711 (Docket No. GRAD/012), issued Mar. 20, 2007, first named inventor Rajit Chandra, and entitled METHOD AND APPARATUS FOR FULL-CHIP ANALYSIS OF SEMICONDUCTOR CHIP DESIGNS, and
International Patent Application Publication No. WO2007070879 (Docket No. GDA_{—}06_{—}10PCT), published Jun. 21, 2007, first named inventor Rajit Chandra, and entitled SIMULATION OF IC TEMPERATURE DISTRIBUTIONS USING AN ADAPTIVE 3D GRID,
   which are hereby incorporated by reference, to the extent permitted by the type of the instant application, in their entirety. The techniques described herein that use full-chip thermal analysis are performable with various full-chip thermal analysis algorithms, though, in some embodiments, some aspects of the techniques are affected by efficiency, accuracy, and/or other properties of the full-chip thermal analysis algorithm used. In some embodiments and/or usage scenarios, the adaptive, grid-based techniques described in “SIMULATION OF IC TEMPERATURE DISTRIBUTIONS USING AN ADAPTIVE 3D GRID” have advantages in efficiency and/or in accuracy.

In some embodiments, a temperature map is used, at least in part, to determine changes to a semiconductor chip design. For example, if the temperature map reveals a region of excessive heat and/or of high temperatures would be present during accelerated testing (or, in various embodiments, during normal operation), one or more changes to the semiconductor chip design are made to affect one or more sources of the excessive heat and/or the high temperatures. The changes are selected to reduce the excessive heat and/or the high temperatures, and/or to make portions of the semiconductor chip design more tolerant of the excessive heat and/or of the high temperatures. According to various embodiments, the changes include one or more of:
changing a type of a transistor, such as by selecting a transistor type with a higher threshold voltage;
changing a width of a transistor;
adding a second transistor in parallel to a first transistor, the second transistor optionally enabled solely during the conditions causing the excessive heat and/or the high temperatures (e.g., during the accelerated testing);
adding or rearranging heating elements, such as transistors or wires;
adding or rearranging cooling elements, such as vias;
rearranging components of the semiconductor chip design;
re-floorplanning the semiconductor chip design; and
modifying packaging and/or cooling (such as a heatsink) of the semiconductor chip design.

In various embodiments, the changes, such as adding a heating element, are designed to increase a local temperature so as to decrease a corresponding local thermal gradient.

In various embodiments, the temperature map produced by the full-chip thermal analysis is used to provide temperature and/or thermal gradient (temperature change) information as a function of location. A thermal gradient aware version of Black's equation:

MTF=A*J_{X}⁻ⁿ*e^{Ea/(k*(T+DTX))}

has an extra parameter, DTX, reflecting a fact that due to thermal gradients, temperature at a location X within the semiconductor chip design differs from the average temperature (T) by an amount DTX, the amount DTX varying throughout the semiconductor chip design based on the temperature map. The parameter DTX is positive or negative, reflecting portions of the semiconductor chip design that are at higher or lower, respectively, temperatures than the average temperature. The current density is represented as J_{X} since, in some embodiments, the current density in the semiconductor chip design varies with location. In other embodiments, the current density is assumed to be constant at all locations in the semiconductor chip design. According to various embodiments, other parameters are also changed based on location and/or based on temperature at a location. In a first example, in some embodiments, the so-called current constant n is dependent on a presence of thermal gradients, and n varies with location according to thermal gradients of the temperature map. In a second example, in some embodiments, the parameter A, which is based on physical properties, varies with location according to local physical properties. Continuing the second example, the parameter A has a different value in a silicon substrate of the semiconductor chip design than in higher layers of metal.

Similarly, a thermal gradient aware lifetime acceleration factor at a location (X) within the semiconductor chip design is given by:

Lc=(Anormal/Aaccel)*(Jnormal_{X}/Jaccel_{X})*e^{[Ea/(k*(Tnormal+DTXnormal))-Ea/(k*Taccel+DTXaccel)]}

where DTXnormal and DTXaccel represent, at location X, respective variations from the respective average temperatures (Tnormal and Taccel) in the normal operating set of conditions and in the accelerated testing set of conditions, and where Jnormal_{X} and Jaccel_{X} represent respective current densities at location X. As described above with regard to the thermal gradient aware version of Black's equation, according to various embodiments, other parameters, such as the so-called current constant n, are also changed based on location and/or based on temperature at a location.

In some embodiments, current density at a location, such as represented by J_{X} in the thermal gradient aware version of Black's equation, is affected by temperature at the location. For example, in some semiconductor chips, thermal resistance of a segment of wire depends on factors such as: a distance from a substrate, a length of the segment, a width of the segment, a heat spreading factor, and a thermal conductivity of layers between the segment and the substrate. Temperature of the segment is based on the thermal resistance and on power dissipated in the segment. The power dissipated in the segment is, in turn, a function of current in the segment and electrical resistance of the segment. In some semiconductor chips, electrical resistance of wire also varies with temperature. Additionally, current in wires is, in some semiconductor chips, sourced from active components such as transistors, and transistor currents also vary with temperature. For example, leakage current increases exponentially with temperature. Accordingly, there is a complex relationship between current density and temperature. A temperature-aware current density at a location is computed as a function, at least in part, of temperature at the location, using relationships such as described above. Using the temperature-aware current density in the thermal gradient aware version of Black's equation and/or in the thermal gradient aware lifetime acceleration factor increases accuracy of these computations.

In some embodiments, full-chip thermal analyses of a semiconductor chip design computed at one or more sets of conditions are used to simulate temperatures expected within semiconductor chips embodying the semiconductor chip design at each of the one or more sets of conditions. In further embodiments, the full-chip thermal analyses are a part of a flow for estimating lifetimes of the semiconductor chips. The full-chip thermal analyses are computed before and/or after performing accelerated life testing of a sample of the semiconductor chips. According to various embodiments, computing at least some of the full-chip thermal analyses prior to the accelerated life testing enables one or more of:
evaluating whether goals of the accelerated life testing are achievable;
evaluating whether stress of the accelerated life testing is able to damage the semiconductor chips;
determining and/or revising conditions of the accelerated life testing; and
changing the semiconductor chip design.

In various embodiments, the accelerated life testing is performed at a set of actual (that is, real-world environmental) conditions that is the same as, or is substantially the same as, one of the sets of conditions. In some embodiments, at least some of the set of actual conditions are measured during the accelerated life testing, and a particular one of the full-chip thermal analyses is computed subsequent to the accelerated life testing at one of the sets of conditions including the measured conditions. Using the measured conditions in the particular full-chip thermal analysis enables more accurate knowledge of temperatures within the semiconductor chips during the accelerated life testing, and accordingly more accurate estimated lifetimes. In further embodiments, if the semiconductor chips fail the accelerated life testing, the full-chip thermal analyses enable changing the semiconductor chip design to avoid and/or to mitigate failure mechanisms.

### MTF, Lc, and DT Maps

In some embodiments, the thermal gradient aware version of Black's equation is used to produce an MTF map of a semiconductor chip design. The MTF map is produced by evaluating the thermal gradient aware version of Black's equation at each of a plurality of grids of the semiconductor chip design, producing a map showing MTF as a function of location (grid). According to various embodiments, the MTF map is a two-dimensional map or a three-dimensional map. For example, a full-chip thermal analysis produces a three-dimensional temperature map of a semiconductor chip design at a specified set of conditions, and the three-dimensional temperature map is used, at least in part, to produce a corresponding MTF map. In various embodiments, the MTF map has different grids than the three-dimensional temperature map, and a temperature at a location (such as a center) of one of the grids of the MTF map is determined by averaging and/or by interpolating the temperature from temperatures of surrounding grids of the three-dimensional temperature map. In some embodiments, the MTF map produced from a three-dimensional temperature map is two-dimensional.

In some embodiments, the thermal gradient aware lifetime acceleration factor is used to produce an Lc map of a semiconductor chip design. The Lc map is produced by evaluating the thermal gradient aware lifetime acceleration factor at each of a plurality of grids of the semiconductor chip design, producing a map showing Lc as a function of location (grid). According to various embodiments, the Lc map is a two-dimensional map or a three-dimensional map. For example, a first full-chip thermal analysis produces a first three-dimensional temperature map of a semiconductor chip design at a first set of conditions, a second full-chip thermal analysis produces a second three-dimensional temperature map of a semiconductor chip design at a second set of conditions, and the first three-dimensional temperature map and the second three-dimensional temperature map are used, at least in part, to produce a corresponding Lc map. In various embodiments, the Lc map has different grids than one or more of the three-dimensional temperature maps, and a temperature at a location (such as a center) of one of the grids of the Lc map (such as a temperature at the first set of conditions or a temperature at the second set of conditions) is determined by averaging and/or by interpolating the temperature from temperatures of surrounding grids of the respective one of the first three-dimensional temperature map and the second three-dimensional temperature map. In some embodiments, the Lc map produced from the three-dimensional temperature maps is two-dimensional. In some embodiments, such as embodiments using adaptive, grid-based techniques for the full-chip thermal analysis, grids of the first three-dimensional temperature map and grids of the second three-dimensional temperature map are different in number and/or in location.

In some embodiments, full-chip thermal analysis of a semiconductor chip design is computed at a first set of conditions, producing a respective first temperature map, and is computed at a second set of conditions, producing a respective second temperature map. In a first example, the first set of conditions represents normal operating conditions, and the second set of conditions represents accelerated testing conditions. In a second example, the first set of conditions represents power-on conditions, and the second set of conditions represents normal operating conditions. In various embodiments, a Differential Temperature (DT) map is produced by taking differences between temperatures of the semiconductor chip design at the second set of conditions (as determined via the second temperature map) and temperatures of the semiconductor chip design at the first set of conditions (as determined via the first temperature map) at each of a plurality of grids. In some embodiments, grids of the DT map do not correspond to grids of either the first temperature map or the second temperature map. A temperature at a particular one of the first set of conditions and the second set of conditions at a location (such as a center) of one of the grids of the DT map is determined by averaging and/or by interpolating the temperature from temperatures of surrounding grids of the respective temperature map. According to various embodiments, the DT map is used to determine one or more of: a maximum temperature difference; a minimum temperature difference; and an average temperature difference. In various embodiments, the DT map is computed implicitly as a part of computing another quantity, such as a maximum temperature difference.

According to various embodiments, gridpoints (defining locations of grids) used in one or more of an MTF map, an Lc map, and a DT map are selected via one or more of: a linear distribution; a non-linear distribution; a distribution that matches gridpoint boundaries in a temperature map; physical attributes of the semiconductor chip design, such as material and/or device boundaries; physical and/or mechanical boundaries of the semiconductor chip design; thermal attributes of the semiconductor chip design, such as boundaries of materials having different thermal properties; locations of steep thermal gradients; locations of higher than average or lower than average temperatures in one or more temperature maps; locations of larger than average differences in temperature between two temperature maps; and other techniques.

In some embodiments, selection of gridpoints is done using a first technique in one dimension, and using a second technique in another dimension. For example, gridpoints in the X and Y dimensions are linearly spaced, whereas gridpoints in the Z dimension correspond to material layers and/or to differences in thermal properties. In some embodiments, a granularity of the gridpoints in one or more dimensions is selected to correspond to and/or to match physical resolutions and/or other information. For example, if failure locations are only computed in the X and Y dimensions (and failure locations do not have an independent Z dimension component), then a number of grids in the Z dimension of an Lc map is selected to be one, resulting in a two-dimensional Lc map.

### Examples of DT Map Use

In some embodiments, a DT map is used to place and/or to configure heating and/or cooling elements and/or thermal diodes or other sensors in a semiconductor chip design. The DT map provides indications of differences in temperatures and/or thermal gradients between a first set of conditions (such as a normal operating set of conditions) and a second set of conditions (such as an accelerated testing set of conditions). For example, a magnitude of the DT map at a particular location indicates a difference in temperature at the particular location, and a slope of the DT map at a particular location indicates a difference in thermal gradients at the particular location. By adding and/or by changing a location of thermal diodes in the semiconductor chip design, the temperature at various locations of interest is monitored, such as during accelerated life testing. By adding heating and/or cooling elements in the semiconductor chip design, and/or by changing a configuration of heating elements already present in the semiconductor chip design, the DT map is selectively “flattened,” “steepened,” or otherwise changed in shape. The DT map is also selectively flattened, steepened, or otherwise changed in shape by other techniques, such as any of the techniques described above with regard to changes to a semiconductor chip design due to regions of excessive heat and/or high temperatures. Flattening the DT map reduces a slope of the DT map (and thus makes the thermal gradients in the first set of conditions and the second set of conditions more similar). Steepening the DT map increases a slope of the DT map (and thus makes the thermal gradients in the first set of conditions and the second set of conditions more different). In a first example, flattening the DT map makes the second set of conditions more uniformly similar to the first set of conditions. In a second example, steepening the DT map makes the accelerated testing set of conditions more stringent in steepened locations, improving efficiency of accelerated testing of the steepened locations.

In a first example, thermal gradients at an accelerated testing set of conditions are smaller than thermal gradients at a normal operating set of conditions, and addition of one or more heating elements is used to increase the thermal gradients at the accelerated testing set of conditions so as to flatten the DT map. In a second example, a location of peak temperature is different in an accelerated testing set of conditions as compared to a normal operating set of conditions, and addition of one or more heating elements is used to make locations of peak temperatures in the respective sets of conditions have substantially a same location. In a third example, heating elements are added to increase temperature in a packaging portion of the semiconductor chip design during accelerated testing, so as to provide sufficient thermal stress for testing of solder balls. In a fourth example, an equivalent effect to adding heating elements is obtained by modifying a power distribution in the semiconductor chip design and/or by changing a floorplan of the semiconductor chip design to rearrange where power is dissipated. In a fifth example, regions of steep (relative to other regions) slope in the DT map (reflecting regions where thermal gradients are different between the accelerated testing set of conditions and the normal operating set of conditions) have more inaccuracy in a local lifetime acceleration factor, due to factors such as a so-called current constant dependent on a presence of thermal gradients. In various embodiments, a particular one of the regions of steep slope in the DT map is managed with techniques such as: adding heating and/or cooling elements to flatten the DT map in the particular region; adding heating elements to the particular region to increase stress during accelerated testing, leading to a more conservative estimated lifetime; adding cooling elements to the particular region to cool the region, at least during normal operation, leading to a longer estimated lifetime; changing the semiconductor chip design to provide additional design margin in the particular region; and increasing an amount of guardband to local lifetime acceleration factors (such as in an Lc map) of the particular region.

According to various embodiments, the addition and/or configuration of heating and/or cooling elements in the semiconductor chip design is used to increase and/or reduce one or more of: a peak magnitude of the DT map; an average magnitude of the DT map; and a magnitude of a specific location in the DT map, such as a location corresponding to a peak in a temperature map. According to various embodiments, a heating and/or cooling element is configured by one or more of: changing a size of the element; changing a location of the element; changing a voltage applied to the element; changing a current applied to the element; changing a resistance of the element; changing a number of vias of the element; changing a thermal conductivity of the element; and changing a composition of the element. According to various embodiments, heating and/or cooling elements include one or more of: active components; passive components; transistors; resistors; wires, such as metal wires; and vias. In some embodiments, the heating and/or cooling elements are added to packaging of semiconductor chips, and are not represented in an integrated circuit portion of the semiconductor chip design. In some embodiments, the effect of the heating and/or cooling elements is achieved by changes in the accelerated testing environment, such as by changing airflow, or by changing a type or a configuration of a heatsink.

According to various embodiments, the addition and/or location of a thermal diode or other sensor in the semiconductor chip design is chosen to monitor one or more of: a location of peak temperature in a temperature map; a location of peak magnitude in a DT map; a location of steep thermal gradients; a location of mechanical stress; a location of mechanical and/or thermal interest, such as a boundary between two materials; and a location susceptible to thermally-induced mechanical stress. In some embodiments, Micro-Electro-Mechanical Systems (MEMS) sensors are added to the semiconductor chip design at positions determined, at least in part, using the DT map. In various embodiments, the MEMS sensors are stress sensors, and are able to measure and/or report mechanical stresses present in the semiconductor chips during the accelerated testing. For example, the sensors measure stress in material of the semiconductor chips during accelerated testing, enabling detection of stress-related failures. Stress-related failures, such as changes in properties of the semiconductor chips with stress, may have a different correlation with temperature than other types of failures, and identifying these failures enables more accurate estimation of lifetime of the semiconductor chips.

### Normal Operating Conditions and Accelerated Testing Conditions

In some embodiments, a full-chip thermal analysis of a semiconductor chip design has inputs including one or more of: a specification of the semiconductor chip design; thermal properties of materials used to manufacture semiconductor chips embodying the semiconductor chip design and/or packaging of the semiconductor chips; library data for components of the semiconductor chip design, such as transistors; and conditions, such as environmental conditions, input conditions, and/or configuration conditions, in which the semiconductor chips are used. According to various embodiments and/or usage scenarios, a full-chip thermal analysis of the semiconductor chip design is computed at (that is, accounting for) a set of the conditions, and the conditions include one or more of:
a power supply voltage level and/or stability of the voltage level applied to the semiconductor chip design;
a current used by the semiconductor chip design at the power supply voltage level,
a frequency of a clock supplied to the semiconductor chip design;
a frequency of a clock within the semiconductor chip design;
an input stimulus of the semiconductor chip design;
an ambient temperature of the semiconductor chip design; airflow at the semiconductor chip design;
a packaging configuration of the semiconductor chip design;
a heatsink configuration of the semiconductor chip design;
a configuration of a heating element within the semiconductor chip design;
a configuration of a cooling element within the semiconductor chip design;
a package temperature of the semiconductor chip design; and
temperatures at one more locations within the semiconductor chip design.

One or more of the conditions are optionally and/or selectively different in a normal operating set of conditions than in an accelerated testing set of conditions, where accelerated life testing of a sample of a plurality of semiconductor chips embodying the semiconductor chip design is performed at, or substantially at, the accelerated testing set of conditions. In a first example, a testing chamber for performing the accelerated life testing of the sample is not identical in airflow to the normal operating set of conditions, leading to differences in thermal gradients between the normal operating set of conditions and the accelerated testing set of conditions. In a second example, the accelerated life testing of the sample provides power and clocking similar to that of the normal operating set of conditions, but does not (due to lack of other system components) provide similar input stimulus, also leading to differences in thermal gradients between the normal operating set of conditions and the accelerated testing set of conditions. In a third example, the accelerated life testing of the sample is performed at a higher ambient temperature than the normal operating set of conditions. In some technologies, device current due to leakage is exponentially dependent on temperature, and the higher ambient temperature causes a higher on-chip temperature, leading to “leaky” devices drawing disproportionately more current. This, in turn, also leads to differences in thermal gradients between the normal operating set of conditions and the accelerated testing set of conditions. Due to these and other factors, it is difficult to determine, without using full-chip thermal analysis at the normal operating set of conditions and at the accelerated testing set of conditions, a relationship between temperature and/or thermal gradients at the normal operating set of conditions and temperature and/or thermal gradients at the accelerated testing set of conditions. Given an exponential relationship of temperature to mean time to failure, an average-temperature-based estimation of Lc for a semiconductor chip design may not be sufficiently accurate since it is more likely that failures at the accelerated testing set of conditions will be at higher temperature portions of the semiconductor chip design, which have a smaller mean time to failure. In some embodiments, other factors, such as a so-called current constant dependent on presence of thermal gradients, also produce location-dependent and/or local-temperature-dependent failure probabilities.

According to various embodiments, computing a full-chip thermal analysis of a semiconductor chip design at a provisional accelerated testing set of conditions enables one or more of:
revising the provisional accelerated testing set of conditions and/or changing the semiconductor chip design to better achieve one or more goals, such as a specified average temperature increase, a specified maximum temperature increase, lessening a magnitude of a DT map, testing a specified portion and/or a specified percentage of the semiconductor chip design at a specified stress level, or a specified lifetime acceleration factor;
ensuring that accelerated testing at the provisional accelerated testing set of conditions is not harmful to semiconductor chips embodying the semiconductor chip design, such as by exceeding a specified maximum temperature at any location (e.g., a material tolerance or melting point); and
optimizing efficiency of accelerated testing at the provisional accelerated testing set of conditions, such as by minimizing a number of the semiconductor chips needed in the accelerated testing and/or a testing time for the accelerated testing.

In some embodiments, a temperature map computed by a full-chip thermal analysis of a semiconductor chip design at a provisional accelerated testing set of conditions is compared against a set of specified maximum temperatures at each of a number of locations within a semiconductor chip embodying the semiconductor chip design and/or within packaging of the semiconductor chip. If at any of the locations, a temperature obtained from the temperature map (optionally via averaging or interpolating) exceeds the respective specified maximum temperature, the provisional accelerated testing set of conditions is revised and/or the semiconductor chip design is changed to decrease temperature at the location, and the computing and comparing are repeated.

In some embodiments, a provisional accelerated testing set of conditions for a semiconductor chip design is revised and/or the semiconductor chip design is changed to achieve one or more goals, such as:
preventing damage to semiconductor chips embodying the semiconductor chip design during accelerated testing;
ensuring sufficient stress, such as a sufficiently high temperature, is achieved in one or more particular portions of the semiconductor chips or of packaging of the semiconductor chips;
achieving specified accelerated testing goals, such as a specified lifetime acceleration factor, or a specified portion and/or a specified fraction of the semiconductor chip design tested at a sufficiently high level of stress; and
optimizing efficiency of accelerated testing at the provisional accelerated testing set of conditions, such as by minimizing a number of the semiconductor chips needed in the accelerated testing and/or a testing time for the accelerated testing.

In various embodiments, subsequent to revising the provisional accelerated testing set of conditions and/or changing the semiconductor chip design, a full-chip thermal analysis computation is performed at the provisional accelerated testing set of conditions, and a determination is made as to whether further revising and/or changing and computing are to be performed to better achieve the goals. In further embodiments, subsequent to changing the semiconductor chip design, a full-chip thermal analysis computation is performed at the normal operating set of conditions.

According to various embodiments, revising a provisional accelerated testing set of conditions and/or changing a semiconductor chip design includes one or more of:
modifying a power supply voltage level and/or stability of the voltage level applied to the semiconductor chip design;
modifying a current used by the semiconductor chip design at the power supply voltage level;
modifying a frequency of a clock supplied to the semiconductor chip design;
modifying a frequency of a clock within the semiconductor chip design;
modifying an input stimulus of the semiconductor chip design;
modifying an ambient temperature of the semiconductor chip design;
modifying airflow at the semiconductor chip design;
modifying a packaging configuration of the semiconductor chip design;
modifying a heatsink configuration of the semiconductor chip design;
modifying a configuration of a heating element within the semiconductor chip design;
modifying a configuration of a cooling element within the semiconductor chip design;
modifying the semiconductor chip design by adding or changing components, such as by adding a second transistor in parallel to a first transistor, or by increasing a width of a transistor, or by changing a type (such as a threshold voltage) of a transistor; and
other techniques, such as any of the techniques described above with regard to changes to a semiconductor chip design due to regions of excessive heat and/or high temperatures.

### Lc Map and Lifetime Estimation

In some embodiments, construction of an Lc map enables more accurate estimation of lifetime of semiconductor chips embodying a semiconductor chip design. In a first example technique, a single lifetime acceleration factor for accelerated testing of a sample of the semiconductor chips is determined based, at least in part, on the Lc map. Determining the lifetime acceleration factor via the Lc map, rather than via a calculation based on an average temperature of the semiconductor chips, produces a more accurate version of the lifetime acceleration factor, and thus a more accurate estimation of the lifetime. In a second example technique, ones of the semiconductor chips failing during, or observed to be failed after, the accelerated testing are analyzed to determine respective failure locations, and the estimation of the lifetime is based, at least in part, on the Lc map and the failure locations. In some embodiments, failing locations are found by analysis of the failed semiconductor chips, such as by visual inspection under a microscope, or by testing on a chip tester to identify a failing circuit or portion thereof.

In some embodiments, an Lc map is used to determine a lifetime acceleration factor for accelerated testing of a sample of the semiconductor chips. The Lc map includes a plurality of grids, each of the grids associated with a respective local lifetime acceleration factor value. According to various embodiments, the grids are in two dimensions or in three dimensions. According to various embodiments, the lifetime acceleration factor is one or more of: an average of values of the Lc map; a weighted average of values of the Lc map; a probabilistic-weighted average of values of the Lc map; a temperature-weighted average of values of the Lc map; combinations of the foregoing; and other averaging and/or statistical techniques. In a first example, values of the Lc map are averaged to produce the lifetime acceleration factor. In a second example, values of the Lc map are weighted, and the weighted values are averaged to produce the lifetime acceleration factor. The weight used for a particular grid of the Lc map is chosen according to one or more of: design criteria, such as an amount of design margin in a portion of the semiconductor chip design corresponding to the particular grid; a physical criteria, such as a type of material in a portion of the semiconductor chip design corresponding to the particular grid; and a usage criteria, such as a duty cycle and/or a frequency of use of a portion of the semiconductor chip design corresponding to the particular grid. In a third example, values of the Lc map are weighted according to a probability, and the weighted values are averaged to produce the lifetime acceleration factor. The probability associated with a particular grid of the Lc map is chosen according to a likelihood of a failure of the portion of the semiconductor chip design corresponding to the particular grid. According to various embodiments, the likelihood of failure is based on one or more of: temperature; thermal gradient; magnitude of the Lc map value associated with the particular grid; a reaction rate computed for the particular grid; and other factors. In a fourth example, values of the Lc map are weighted according to temperatures at the corresponding locations of the semiconductor chip design during accelerated testing, and the weighted values are averaged to produce the lifetime acceleration factor. The temperatures are produced by a full-chip thermal analysis at the accelerated testing set of conditions. In some embodiments, the temperature-based weighting is linear with temperature. In some embodiments, the temperature-based weighting is exponential with temperature.

In some embodiments, an Lc map and one or more failure locations are used to determine an estimated lifetime of the semiconductor chips. According to various embodiments, the respective failure locations are identified in two dimensions or in three dimensions within the failing semiconductor chips, and the Lc map is correspondingly a two-dimensional or a three-dimensional map. In some embodiments, an estimated lifetime analysis is performed that, instead of treating the semiconductor chip design as a unit, treats each grid of the Lc map (corresponding to a portion of the semiconductor chip design) independently. In other embodiments, one or more grids not corresponding to any of the failure locations are aggregated, and ones of the grids corresponding to ones of the failure locations are treated independently. Techniques contemplated for combining the Lc map information and the failure locations advantageously use fine-grained information of the Lc map and/or of the failure locations to produce the estimated lifetime. For example, knowledge of the failure locations, considering likelihood of failure at each of the failure locations, provides added information about the estimated lifetime and/or accuracy of the estimated lifetime.

In one example technique, each grid of the Lc map is treated as a separate entity, and a separate estimated lifetime analysis is done for each of the grids based on failures of each of the grids (across the sample of the semiconductor chips used in the accelerated testing) as determined by the failure locations, producing a respective estimated lifetime for each grid. The estimated lifetime of the semiconductor chips is then taken as a minimum of the respective estimated lifetimes of the grids, as failure of any of the portions of the semiconductor chips represented by the grids results in failure of the semiconductor chips. More complex analysis techniques use the failure locations and other information to provide weighting and or statistical ways of computing the estimated lifetime, where a failure attributed to a particular grid provides information about a likelihood of failure of other grids. For example, a failure attributed by a failure location to a particular one of the grids is distributed among the particular grid and neighboring ones of the grids. Instead of assigning one failure to the particular grid, the particular grid is assigned 0.6 of a failure, and each of eight surrounding grids (assuming a two-dimensional Lc map) is assigned 0.05 of a failure. In a variation of the example, the failure is distributed based on failure probabilities, temperatures, DT map values and/or slope, or other factors, so that the particular grid and each of the surrounding grids receives a different portion of the failure.

### EXAMPLE EMBODIMENTS

In concluding the introduction to the detailed description, what follows is a collection of example embodiments, including at least some explicitly enumerated as “ECs” (Example Combinations), providing additional description of a variety of embodiment types in accordance with the concepts described herein; these examples are not meant to be mutually exclusive, exhaustive, or restrictive; and the invention is not limited to these example embodiments but rather encompasses all possible modifications and variations within the scope of the issued claims.

EC1) A system including:
means for computing temperature maps of a semiconductor chip design at respective sets of conditions;
means for evaluating differences between a first one of the temperature maps and a second one of the temperature maps, the first temperature map computed at a first one of the sets of conditions, and the second temperature map computed at a second one of the sets of conditions; and
means for estimating a lifetime of semiconductor chips built using the semiconductor chip design.

EC2) The system of EC1, wherein a particular one of the sets of conditions includes one or more of
a power supply voltage level and/or stability of the voltage level applied to the semiconductor chip design,
a current used by the semiconductor chip design at the power supply voltage level,
a frequency of a clock supplied to the semiconductor chip design,
a frequency of a clock within the semiconductor chip design,
an input stimulus of the semiconductor chip design,
an ambient temperature of the semiconductor chip design,
airflow at the semiconductor chip design,
a packaging configuration of the semiconductor chip design,
a heatsink configuration of the semiconductor chip design,
a configuration of a heating element within the semiconductor chip design,
a configuration of a cooling element within the semiconductor chip design,
a package temperature of the semiconductor chip design, and
temperatures at one more locations within the semiconductor chip design.

The system of EC2, wherein the configuration of the heating element includes a respective current applied to the heating element.

The system of EC2, wherein the configuration of the heating element includes a respective voltage applied to the heating element.

The system of EC2, wherein the configuration of the heating element includes a resistance of the heating element.

The system of EC2, wherein the configuration of the heating element includes a location of the heating element.

EC3) The system of EC1, further including means for performing accelerated life testing of a plurality of the semiconductor chips.

EC4) The system of EC3, wherein a result of the means for performing is an input to the means for estimating.

The system of EC4, wherein the result includes a number of the plurality that failed due to the means for performing.

The system of EC4, wherein the means for estimating is further based, at least in part, on a result of the means for evaluating.

The system of EC3, wherein the means for performing is enabled to use test conditions substantially the same as the second set of conditions.

EC5) The system of EC1, wherein the first set of conditions is normal operating conditions.

The system of EC5, wherein the normal operating conditions are worst-case normal operating conditions.

The system of EC1, wherein the second set of conditions is accelerated testing conditions.

EC6) The system of EC1, wherein the means for computing includes a full-chip thermal analysis.

The system of EC6, wherein the full-chip thermal analysis is a two-dimensional thermal analysis.

The system of EC6, wherein the full-chip thermal analysis is a transient thermal analysis.

EC7) The system of EC6, wherein the full-chip thermal analysis is a three-dimensional thermal analysis.

The system of EC7, wherein the full-chip thermal analysis is based, at least in part, on adaptive, grid-based techniques.

The system of EC1, wherein the differences are, at least in part, an input to the means for estimating.

EC8) The system of EC1, wherein the means for evaluating includes computing a differential temperature map.

EC9) The system of EC8,
further including means for determining a third one of the sets of conditions based, at least in part, on the differential temperature map; and
wherein the means for computing is enabled to compute a third one of the temperature maps at the third set of conditions.

EC10) The system of EC9, wherein the third temperature map is, at least in part, an input to the means for estimating.

The system of EC10,
further including means for performing accelerated life testing of a plurality of the semiconductor chips; and
wherein the means for performing is enabled to use test conditions substantially the same as the third set of conditions.

EC11) The system of EC1,
further including means for determining a third one of the sets of conditions based, at least in part, on a result of the means for evaluating; and
wherein the means for computing is enabled to compute a third one of the temperature maps at the third set of conditions.

The system of EC11, wherein the first temperature map and the third temperature map are, at least in part, inputs to the means for estimating.

EC12) The system of EC11,
wherein the means for evaluating is a first means for evaluating; and
further including second means for evaluating differences, the second means for evaluating operating, at least in part, on the first temperature map and the third temperature map.

The system of EC12, wherein a result of the second means for evaluating is an input to the means for estimating.

EC13) The system of EC11, further including means for performing accelerated life testing of a plurality of the semiconductor chips.

The system of EC13, wherein a result of the means for performing is an input to the means for estimating.

The system of EC13, wherein the means for performing is enabled to use test conditions substantially the same as the third set of conditions.

The system of EC1, wherein the means for estimating is operable according to the Arrhenius life-stress model.

EC14) A system including:
means for computing temperature maps of a semiconductor chip design at respective sets of conditions;
means for estimating a lifetime of semiconductor chips built using the semiconductor chip design; and
means for performing accelerated life testing of a plurality of the semiconductor chips.

EC15) The system of EC14, further including means for measuring at least some test conditions of the accelerated life testing.

EC16) The system of EC15,
wherein an accelerated testing one of the sets of conditions includes the measured test conditions, and the means for computing is enabled to compute an accelerated testing one of the temperature maps at the accelerated testing set of conditions;
wherein a normal one of the sets of conditions represents normal operating conditions of the semiconductor chips, and the means for computing is enabled to compute a normal one of the temperature maps at the normal set of conditions; and
further including means for evaluating differences between the accelerated testing temperature map and the normal temperature map.

The system of EC16, wherein the normal operating conditions are worst-case normal operating conditions.

EC17) The system of EC16, wherein a result of the means for evaluating is an input to the means for estimating.

The system of EC17, wherein the means for evaluating includes means for computing a differential temperature map.

EC18) The system of EC17, wherein the means for evaluating includes means for computing a difference in temperature between a peak value of the normal temperature map and a value at a corresponding location of the accelerated testing temperature map.

The system of EC18, further including means for interpolating, the means for interpolating operable to determine the value at the corresponding location.

The system of EC17, wherein the means for evaluating includes means for computing a difference in temperature between a peak value of the accelerated testing temperature map and a value at a corresponding location of the normal temperature map.

EC19) The system of EC17, wherein the means for evaluating includes means for computing a lifetime acceleration factor map.

The system of EC19, wherein the means for computing the lifetime acceleration factor map is based, at least in part, on temperature-aware current density.

The system of EC19, wherein the means for computing the lifetime acceleration factor map is based, at least in part, on a so-called current constant dependent on thermal gradients.

EC20) The system of EC19, wherein the lifetime acceleration factor map is, at least in part, an input to the means for estimating.

The system of EC20, wherein the means for estimating is operable to determine a maximum of lifetime acceleration factors of the lifetime acceleration factor map.

The system of EC20, wherein the means for estimating is operable to determine an average of lifetime acceleration factors of the lifetime acceleration factor map.

EC21) The system of EC20, wherein the means for estimating is operable to determine a weighted average of lifetime acceleration factors of the lifetime acceleration factor map.

The system of EC21, wherein the weighting is based, at least in part, on thermal gradients of one of the temperature maps.

The system of EC19, wherein a grid of the lifetime acceleration factor map is two dimensional.

The system of EC19, wherein a grid of the lifetime acceleration factor map is, at least in part, according to physical attributes of the semiconductor chip design.

The system of EC19, wherein a grid of the lifetime acceleration factor map is coarser than a grid of the accelerated testing temperature map.

The system of EC19, wherein a grid of the lifetime acceleration factor map is the same as a grid of the accelerated testing temperature map.

EC22) The system of EC19, wherein the means for computing the lifetime acceleration factor map includes a means for determining a lifetime acceleration factor at each of a plurality of grids of the lifetime acceleration factor map.

The system of EC22, wherein the means for determining the lifetime acceleration factor is based, at least in part, on the Arrhenius life-stress model.

The system of EC22, wherein the means for determining the lifetime acceleration factor is based, at least in part, on a temperature-aware current density.

EC23) The system of EC22, wherein the means for determining the lifetime acceleration factor at a particular one of the grids includes means for determining a corresponding temperature at the particular grid.

The system of EC23, wherein the means for determining the corresponding temperature is operable to interpolate a temperature at a location corresponding to the particular grid from temperatures of surrounding grids of the accelerated testing temperature map.

The system of EC19, wherein the means for estimating includes means for computing a lifetime acceleration factor for the semiconductor chip design based, at least in part, on the lifetime acceleration factor map.

The system of EC17, wherein the means for estimating is operable according to the Arrhenius life-stress model.

The system of EC14, wherein the means for estimating is operable according to the Arrhenius life-stress model.

The system of EC14, wherein the means for estimating is operable according to a temperature-aware current density.

EC24) The system of EC14, wherein the means for computing includes a full-chip thermal analysis.

The system of EC24, wherein the full-chip thermal analysis is a two-dimensional thermal analysis.

The system of EC24, wherein the full-chip thermal analysis is a transient thermal analysis.

EC25) The system of EC24, wherein the full-chip thermal analysis at a particular one of the sets of conditions accounts, at least in part, for the particular set of conditions.

The system of EC25, wherein the particular set of conditions includes one or more of
a power supply voltage level and/or stability of the voltage level applied to the semiconductor chip design,
a current used by the semiconductor chip design at the power supply voltage level,
a frequency of a clock supplied to the semiconductor chip design,
a frequency of a clock within the semiconductor chip design,
an input stimulus of the semiconductor chip design,
an ambient temperature of the semiconductor chip design,
airflow at the semiconductor chip design,
a packaging configuration of the semiconductor chip design,
a heatsink configuration of the semiconductor chip design,
a configuration of a heating element within the semiconductor chip design,
a configuration of a cooling element within the semiconductor chip design,
a package temperature of the semiconductor chip design, and
temperatures at one more locations within the semiconductor chip design.

EC26) A method including:
computing, via full-chip thermal analysis, a first temperature map of a semiconductor chip design at a first set of conditions;
computing, via full-chip thermal analysis, a second temperature map of the semiconductor chip design at a second set of conditions; and
evaluating differences between the first temperature map and the second temperature map.

EC27) The method of EC26, further including performing accelerated life testing of a portion of a plurality of semiconductor chips embodying the semiconductor chip design.

The method of EC27, wherein the performing is at conditions substantially the same as the second set of conditions.

EC28) The method of EC27,
wherein the performing is at a third set of conditions; and
further including determining the third set of conditions based, at least in part, on a result of the evaluating.

The method of EC28, wherein the determining is according to ensuring that a maximum of the differences is less than a specified value.

The method of EC28,
wherein the determining is according to ensuring that a maximum of lifetime acceleration factors of a lifetime acceleration factor map is at least a specified value; and
wherein the lifetime acceleration factor map is based, at least in part, on the differences.

The method of EC28, wherein the determining is according to ensuring that a minimum of lifetime acceleration factors of a lifetime acceleration factor map is at least a specified value.

EC29) The method of EC28, further including computing, via full-chip thermal analysis, a third temperature map of the semiconductor chip design at the third set of conditions.

The method of EC29, wherein the determining is according to ensuring that a maximum of values of the third temperature map is less than a specified maximum temperature.

The method of EC29, wherein the determining is according to ensuring that at each of a plurality of locations, a value of the third temperature map corresponding to the each location is less than a respective specified maximum temperature of the each location.

EC30) The method of EC29, further including estimating a lifetime of the semiconductor chips.

The method of EC30, wherein the estimating is based, at least in part, on the third temperature map.

The method of EC30, wherein the estimating is based, at least in part, on the first temperature map.

The method of EC30, wherein the estimating is based, at least in part, on the Arrhenius life-stress model.

The method of EC30, wherein the estimating is based, at least in part, on a thermal gradient aware version of Black's equation.

The method of EC30, wherein the estimating is based, at least in part, on a thermal gradient aware lifetime acceleration factor equation.

EC31) The method of EC28, wherein the third set of conditions includes a configuration of a heating element within the semiconductor chip design.

The method of EC31, wherein the configuration includes an amount of current applied to the heating element.

The method of EC31, wherein the configuration includes a resistance of the heating element.

The method of EC31, wherein the configuration includes a location of the heating element.

EC32) The method of EC28, wherein the evaluating produces a differential temperature map.

The method of EC32, wherein the determining is according to ensuring that a region of relative steep slope in the differential temperature map is flattened.

The method of EC26, wherein the evaluating produces a lifetime acceleration factor map.

EC33) The method of EC26, further including producing a lifetime acceleration factor map based, at least in part, on a result of the evaluating.

EC34) The method of EC33, wherein the producing is based, at least in part, on a thermal gradient aware version of a lifetime acceleration factor equation.

The method of EC34, wherein the thermal gradient aware version of the lifetime acceleration factor equation includes a temperature-aware current density term.

The method of EC34, wherein the thermal gradient aware version of the lifetime acceleration factor equation includes a so-called current constant dependent on thermal gradients.

EC35) The method of EC33, further including estimating a lifetime of semiconductor chips embodying the semiconductor chip design based, at least in part, on the lifetime acceleration factor map.

EC36) The method of EC35,
further including performing accelerated life testing of a sample of the semiconductor chips; and
wherein the estimating is further based, at least in part, on a result of the performing.

The method of EC36, wherein the result includes a number of the sample that failed during the performing.

EC37) The method of EC36, further including analyzing one or more of the sample that failed during the performing.

EC38) The method of EC37, wherein the analyzing determines a failure location within a failed one of the sample.

The method of EC38, wherein the estimating is further based, at least in part, on an estimated lifetime of a portion less than all of the semiconductor chip design, the portion corresponding to the failure location.

EC39) The method of EC26, further including estimating a lifetime of semiconductor chips embodying the semiconductor chip design based, at least in part, on the differences.

The method of EC39, wherein the differences include a difference between a first peak temperature of the first temperature map and a second peak temperature of the second temperature map.

The method of EC39, wherein the differences include a difference between a first temperature at a location of the of the first temperature map and a second temperature at a corresponding location of the second temperature map.

EC40) The method of EC39, wherein the differences include a difference between a first peak temperature of the first temperature map and a second corresponding temperature of the second temperature map.

EC41) A method including:
computing, via full-chip thermal analysis, a first peak temperature of a semiconductor chip design at a first set of conditions;
computing, via full-chip thermal analysis, a second corresponding temperature of the semiconductor chip design at a second set of conditions; and
estimating a lifetime of semiconductor chips embodying the semiconductor chip design based, at least in part, on the first peak temperature and the second corresponding temperature.

The method of either EC40 or EC41, wherein the first peak temperature and the second corresponding temperature are with respect to a same location of the semiconductor chip design.

EC42) The method of either EC40 or EC41,
further including computing, via full-chip thermal analysis, a third temperature of the semiconductor chip design at a third set of conditions; and
determining the second set of conditions based, at least in part, on the third temperature.

The method of EC42, wherein the first peak temperature and the third temperature are with respect to a same location of the semiconductor chip design.

The method of EC42, wherein the determining is according to ensuring that the second corresponding temperature is less than a specified maximum temperature.

The method of either EC40 or EC41, wherein each of the sets of conditions includes one or more of
a power supply voltage level and/or stability of the voltage level applied to the semiconductor chip design,
a current used by the semiconductor chip design at the power supply voltage level,
a frequency of a clock supplied to the semiconductor chip design,
a frequency of a clock within the semiconductor chip design,
an input stimulus of the semiconductor chip design,
an ambient temperature of the semiconductor chip design,
airflow at the semiconductor chip design,
a packaging configuration of the semiconductor chip design,
a heatsink configuration of the semiconductor chip design,
a configuration of a heating element within the semiconductor chip design,
a configuration of a cooling element within the semiconductor chip design,
a package temperature of the semiconductor chip design, and
temperatures at one more locations within the semiconductor chip design.

EC43) A method including:
computing, via full-chip thermal analysis, a first temperature map of a semiconductor chip design at a first set of conditions;
computing, via full-chip thermal analysis, a second temperature map of the semiconductor chip design at a second set of conditions;
determining, using at least in part the first temperature map and the second temperature map, a lifetime acceleration factor map; and
estimating a lifetime of semiconductor chips embodying the semiconductor chip design based, at least in part, on the lifetime acceleration factor map.

EC44) The method of EC43, wherein the determining is according to a thermal gradient aware lifetime acceleration factor equation.

The method of EC44, wherein the thermal gradient aware lifetime acceleration factor equation includes a temperature-aware current density term.

The method of EC44, wherein the thermal gradient aware lifetime acceleration factor equation includes a so-called current constant dependent on thermal gradients.

EC45) The method of EC43, further including performing accelerated life testing of a plurality of the semiconductor chips.

The method of EC45, wherein the performing is at conditions substantially the same as the second set of conditions.

EC46) The method of EC45, wherein the performing is at a third set of conditions.

The method of EC46, further including determining the third set of conditions based, at least in part, on the first temperature map.

The method of EC46, further including measuring, during the performing, at least some of the conditions of the second set of conditions.

EC47) A method including:
computing, via full-chip thermal analysis, a first temperature map of a semiconductor chip design at a first set of conditions;
computing, via full-chip thermal analysis, a second temperature map of the semiconductor chip design at a second set of conditions;
determining, from the first temperature map and the second temperature map, a differential temperature map; and
determining locations of one or more heating elements in the semiconductor chip design based, at least in part, on the differential temperature map.

The method of EC47, further including adding the heating elements to the semiconductor chip design.

The method of EC47, wherein the determining locations is operable in two dimensions.

The method of EC47, wherein the determining locations is operable in three dimensions.

EC48) The method of EC47, wherein at least one of the heating elements includes one or more active components of the semiconductor chip design.

The method of EC48, wherein the active components are a primary source of heat of the at least one of the heating elements.

The method of EC48, wherein the active components are transistors.

EC49) The method of EC47, wherein at least one of the heating elements includes one or more resistive components of the semiconductor chip design.

The method of EC49, wherein the resistive components are a primary source of heat of the at least one of the heating elements.

The method of EC49, wherein the resistive components are wires.

The method of EC47, wherein the determining locations is according to decreasing a magnitude of the differential temperature map.

The method of EC47, wherein the determining locations is according to decreasing a peak magnitude of the differential temperature map.

The method of EC47, wherein the determining locations is according to decreasing a slope of the differential temperature map.

EC50) A method including:
computing, via full-chip thermal analysis, a first temperature map of a semiconductor chip design at a first set of conditions;
computing, via full-chip thermal analysis, a second temperature map of the semiconductor chip design at a second set of conditions;
determining, from the first temperature map and the second temperature map, a differential temperature map; and
determining locations of one or more elements in the semiconductor chip design based, at least in part, on the differential temperature map.

EC51) The method of EC50, further including adding the elements to the semiconductor chip design.

The method of EC51, wherein the elements are selected from the group consisting of heating elements, cooling elements, thermal diodes, and sensors.

The method of EC51, wherein the elements are heating elements.

The method of EC51, wherein the elements are Micro-Electro-Mechanical Systems (MEMS) sensors.

The method of EC50, wherein the determining determines at least one of the locations as a location of greatest magnitude of the differential temperature map.

The method of EC50, wherein the determining determines at least one of the locations as a location of greatest magnitude of the first temperature map.

The method of EC50, wherein the determining determines at least one of the locations as a location of relative steep thermal gradients of the first temperature map.

The method of EC50, wherein the determining determines at least one of the locations as a location of relative steep slope of the differential temperature map.

EC52) A method including:
computing, via full-chip thermal analysis at respective sets of conditions, one or more temperature maps of a semiconductor chip design, the semiconductor chip design embodied in a plurality of semiconductor chips;
revising, based at least in part on the computing, a testing chamber one of the sets of conditions;
performing accelerated life testing of a sample of the semiconductor chips, the performing at accelerated testing conditions; and
estimating a lifetime of the semiconductor chips based, at least in part, on a result of the performing.

The method of EC52, wherein the sample is 100 or more of the semiconductor chips.

The method of EC52, further including initially defining the accelerated testing conditions.

The method of EC52, further including iterating the computing and the revising.

The method of EC52, wherein the result includes a number of the sample that failed during the performing.

The method of EC52, wherein the result includes a number of the sample that failed during the performing, or are determined to be failed after the performing.

EC53) The method of EC52, wherein the accelerated testing conditions are substantially the same as the testing chamber set of conditions.

EC54) The method of EC53,
wherein a normal one of the sets of conditions represents normal operating conditions of the semiconductor chips, and the computing is enabled to compute a normal one of the temperature maps at the normal set of conditions; and
further including determining the testing chamber set of conditions based, at least in part, on the normal temperature map.

The method of EC54, wherein the determining constructs the testing chamber set of conditions so as to achieve a specified lifetime acceleration factor for the performing.

EC55) The method of EC54, wherein the computing is enabled to compute a testing chamber one of the temperature maps at the testing chamber set of conditions.

The method of EC55, wherein the determining constructs the testing chamber set of conditions so as to produce a specified temperature difference between a peak temperature of the normal temperature map and a peak temperature of the testing chamber temperature map.

The method of EC55, wherein the determining constructs the testing chamber set of conditions so as to produce a specified temperature difference between a peak temperature of the normal temperature map and a temperature at a corresponding location of the testing chamber temperature map.

The method of EC55, wherein the determining constructs the testing chamber set of conditions so as to produce a specified temperature difference between a peak temperature of the testing chamber temperature map and a temperature at a corresponding location of the normal temperature map.

The method of EC55, wherein the determining constructs the testing chamber set of conditions to ensure that a maximum temperature of the testing chamber temperature map is less than a specified amount.

The method of EC55, wherein the determining constructs the testing chamber set of conditions to ensure that at each of a plurality of locations, a value of the testing chamber temperature map corresponding to the each location is less than a respective specified maximum temperature of the each location.

EC56) The method of EC52, further including measuring at least some conditions during the performing.

EC57) The method of EC56,
wherein an accelerated testing one of the sets of conditions includes the measured conditions, and the computing is enabled to compute an accelerated testing one of the temperature maps at the accelerated testing set of conditions; and
wherein a normal one of the sets of conditions represents normal operating conditions of the semiconductor chips, and the computing is enabled to compute a normal one of the temperature maps at the normal set of conditions.

EC58) The method of EC57, further including evaluating differences between the accelerated testing temperature map and the normal temperature map.

The method of EC58, wherein the estimating is further based, at least in part, on a result of the evaluating.

The method of EC58, wherein the evaluating includes determining a difference between a peak temperature of the accelerated testing temperature map and a peak temperature of the normal temperature map.

The method of EC58, wherein the evaluating includes determining a difference between a peak temperature of the accelerated testing temperature map and a temperature at a corresponding location of the normal temperature map.

The method of EC58, wherein the evaluating includes determining a difference between a peak temperature of the normal temperature map and a temperature at a corresponding location of the accelerated testing temperature map.

The method of EC58, wherein the evaluating includes determining a first temperature at a location of the normal temperature map and a second temperature at a corresponding location of the accelerated testing temperature map.

EC59) The method of EC58, wherein the evaluating includes determining a lifetime acceleration factor map.

The method of EC58, wherein the determining is based, at least in part, on a thermal gradient aware lifetime acceleration factor equation.

EC60) The method of EC59, wherein the determining is based, at least in part, on the differences.

The method of EC60, wherein a number of gridpoints of the lifetime acceleration factor map is fewer than a number of gridpoints of the accelerated testing temperature map.

The method of EC52, wherein the estimating is further based, at least in part, on the Arrhenius life-stress model.

EC61) A method including:
computing, via full-chip thermal analysis at a normal operating set of conditions, a normal operating temperature map of a semiconductor chip design;
computing, via full-chip thermal analysis at a testing set of conditions, a testing temperature map of the semiconductor chip design;
evaluating differences between the testing temperature map and the normal operating temperature map; and
revising the testing set of conditions or changing the semiconductor chip design based, at least in part, on a result of the evaluating.

EC62) The method of EC61, further including performing accelerated life testing of a portion of a plurality of semiconductor chips embodying the semiconductor chip design.

EC63) The method of EC62, wherein the performing is at conditions substantially the same as the testing set of conditions.

EC64) The method of EC62, further including defining, prior to computing the testing temperature map, the testing set of conditions.

The method of EC64, wherein the defining is based, at least in part, on a specified lifetime acceleration factor of the performing.

EC65) The method of EC61, further including iterating the computing the normal operating temperature map, the computing the testing temperature map, the evaluating, and the revising or the changing.

The method of EC65, wherein the revising includes configuring elements of the semiconductor chip design.

The method of EC65, wherein the revising includes modifying an ambient temperature.

The method of EC65, further including selecting one or more of the revising and the changing based, at least in part, on the evaluating.

EC66) The method of EC65, wherein the changing includes changing the location of at least one element of the semiconductor chip design.

The method of EC66, wherein the at least one element is a heating element.

The method of EC66, wherein the at least one element is a wire.

EC67) The method of EC65, wherein the changing includes adding at least one element to the semiconductor chip design.

The method of EC67, wherein the at least one element is a heating element.

The method of EC67, wherein the at least one element is a wire.

EC68) The method of EC65, wherein the changing includes changing a current applied to at least one element of the semiconductor chip design.

The method of EC68, wherein the at least one element is a heating element.

EC69) The method of EC61, further including iterating the computing the testing temperature map, the evaluating, and the revising.

EC70) The method of EC69, further including defining, prior to first computing the testing temperature map, the testing set of conditions.

The method of EC70, wherein the defining is based, at least in part, on a specified temperature differential between the normal operating set of conditions and the testing set of conditions.

The method of EC70, wherein the defining is based, at least in part, on a specified lifetime acceleration factor.

A computer readable medium having a set of instructions stored therein which when executed by a processing element causes the processing element to perform procedures including: implementing the method of any of EC26 to EC70.

### Estimating Lifetimes

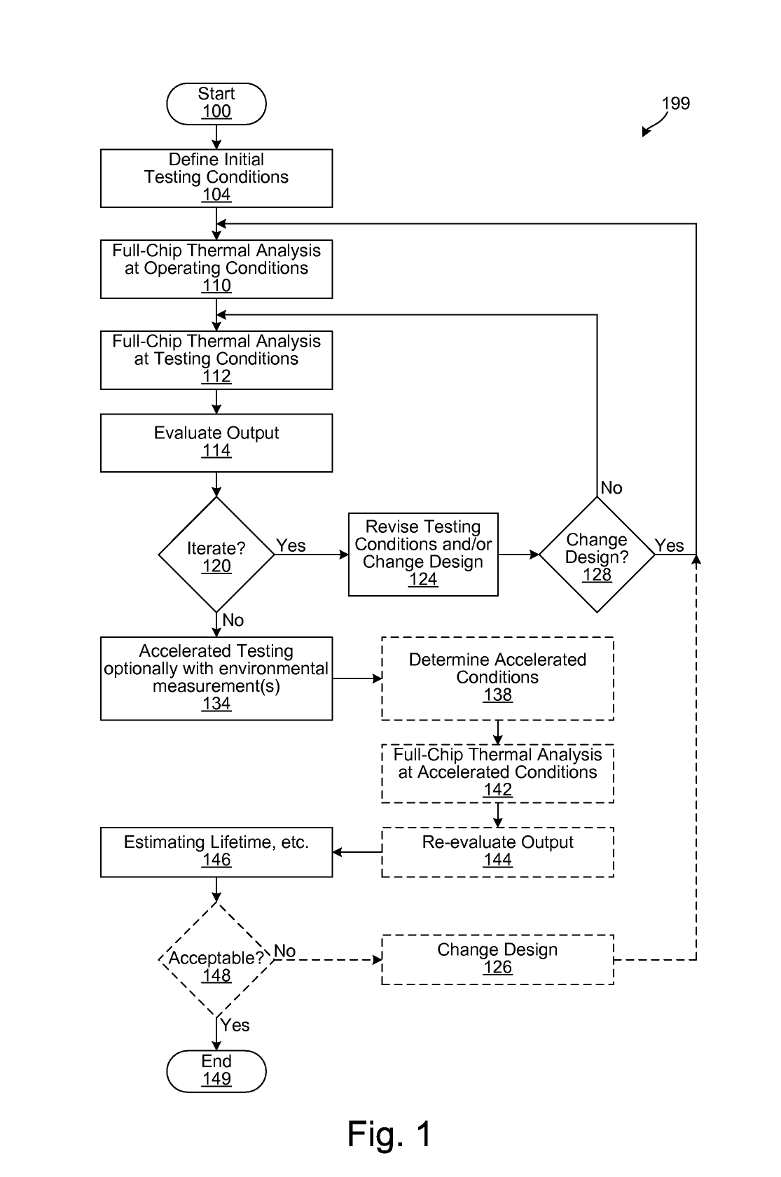

FIG. 1 is a flow diagram illustrating selected details of an embodiment of estimating semiconductor chip lifetimes. Overall, flow 199 includes defining an initial testing set of conditions for a semiconductor chip design, computing full-chip thermal analyses at a normal operating set of conditions and at the testing set of conditions, evaluating output (such as temperature maps) of the thermal analyses to produce results such as a DT map, optionally and/or selectively iterating some or all of the foregoing in combination with revising the testing set of conditions and/or changing the semiconductor chip design, performing accelerated testing at or substantially at the testing set of conditions optionally with measurement of actual accelerated conditions, optionally revising the results based, at least in part, on the measurements, and estimating a lifetime and/or determining other statistics of semiconductor chips embodying the semiconductor chip design. In certain embodiments each of the elements of the flow includes internal functions to determine acceptability of results, iterate as necessary to improve the results, and to direct feedback to earlier processing functions of the flow as needed.

Processing of flow 199 begins (“Start” 100) and proceeds to define an initial testing set of conditions (“Define Initial Testing Conditions” 104) for accelerated testing of a sample of a plurality of semiconductor chips embodying a semiconductor chip design. A full-chip thermal analysis is then computed at a normal operating set of conditions (“Full-Chip Thermal Analysis at Operating Conditions” 110), and a full-chip thermal analysis is computed at the testing set of conditions (“Full-Chip Thermal Analysis at Testing Conditions” 112). Output of each of the thermal analyses includes a temperature map in, according to various embodiments, either two dimensions or three dimensions. The output of the thermal analyses is evaluated (“Evaluate Output” 114), to produce results including one or more of: an average temperature at the normal operating set of conditions; an average temperature at the testing set of conditions; a peak temperature at the normal operating set of conditions; a peak temperature at the testing set of conditions; a maximum temperature difference between corresponding locations of the temperature maps; and a DT map.

A decision is then made as to whether the processing iterates (“Iterate?” 120). According to various embodiments, the processing iterates to better achieve a goal of the accelerated testing, such as to prevent damage to the semiconductor chips during the accelerated testing. For example, if the temperature map for the testing set of conditions indicates that a location in the semiconductor chip design exceeds a temperature limit for the location, the processing iterates.

If the processing iterates, then the testing set of conditions is revised and/or the semiconductor chip design is changed (“Revise Testing Conditions and/or Change Design” 124). According to various embodiments, the testing set of conditions is optionally and/or selectively revised for reasons such as: a specified parameter, such as a specified maximum temperature for one of the temperature maps, is exceeded; and a specified goal of the accelerated testing, such as a specified lifetime acceleration factor, is not achieved. In some embodiments and/or usage scenarios, the testing set of conditions is optionally and/or selectively revised, such as by reducing an ambient temperature during testing. According to various embodiments, the semiconductor chip design is optionally and/or selectively changed for reasons such as: a change to the semiconductor chip design is able to achieve, at least in part, a goal of the accelerated testing; and a change to the semiconductor chip design is able to prevent or to better tolerate a harmful condition, such as a maximum temperature above a specified value. In some embodiments and/or usage scenarios, the semiconductor chip design is optionally and/or selectively changed, such as by adding a heating element and/or a cooling element, or by changing a location or a type of a component. For example, if excessive heating in a portion of the semiconductor chip design is due, at least in part, to leakage current, changing a low-threshold type of transistor used to a higher-threshold type of transistor is able to reduce the leakage current. If the semiconductor chip design is changed (“Change Design?” 128), then the full-chip thermal analysis at the normal operating set of conditions and subsequent elements of the flow are repeated. If the semiconductor chip design is not changed, then the full-chip thermal analysis at the testing set of conditions and subsequent elements of the flow are repeated.

If the processing does not iterate or when the iterating terminates, then accelerated testing is performed (“Accelerated Testing” 134). The accelerated testing is performed at, or substantially at, conditions of the testing set of conditions. Optionally, one or more conditions present during the accelerated testing are measured. For example, an ambient temperature at a package of one of the semiconductor chips is measured. The accelerated testing is performed using the sample of the semiconductor chips, and determines a number of the sample that fail during, or are observed to be failed after, the accelerated testing. In some embodiments, the accelerated testing includes analysis to determine failure locations in at least some of the failed ones of the sample.

If optional measurements of conditions are made during the accelerated testing, then optionally an accelerated testing set of conditions is determined (“Determine Accelerated Conditions” 138). In some embodiments, the accelerated testing set of conditions includes at least some of the measured conditions. In some embodiments, the accelerated testing set of conditions is the testing set of conditions, with particular ones of the conditions that were measured during the accelerated testing replaced by the measured conditions. Then, a full-chip thermal analysis is computed at the accelerated testing set of conditions (“Full-Chip Thermal Analysis at Accelerated Conditions” 142). The output of the thermal analyses is re-evaluated (“Re-evaluate Output” 144) using the full-chip thermal analysis computed at the accelerated testing set of conditions, rather than the full-chip thermal analysis computed at the testing set of conditions, to produce a more accurate version of the results.

Using, at least in part, the output of the final full-chip thermal analysis computed at the testing set of conditions, or the output of the full-chip thermal computed at the accelerated testing set of conditions if the optional measurements are taken during the accelerated testing, an analysis of the results of the accelerated testing is performed (“Estimating Lifetime, etc.” 146). According to various embodiments, the analysis of the results is further based, at least in part, on one or more of: information regarding failures during the accelerated testing; the output of the full-chip thermal analysis computed at the normal operating set of conditions; a DT map; and an LC map. In further embodiments, the information regarding failures includes the failure locations. In various embodiments, the analysis of the results produces statistics of the semiconductor chips such as an estimated lifetime, a mean lifetime, failure rate, reliability over time, and confidence bounds on accuracy of the statistics. In some embodiments, the flow then ends (“End” 149). In other embodiments, the statistics, such as the estimated lifetime, are examined to determine if the semiconductor chip design is acceptable (“Acceptable?” 148). For example, if the estimated lifetime is less than a specified target lifetime, the semiconductor chip design is not acceptable. If the statistics are acceptable, then the flow ends (“End” 149).

If the statistics are not acceptable, then the design is changed (“Change Design” 126). In various embodiments, the analysis of the results of the accelerated testing identifies a particular failure mechanism, and one or more design changes are selected to prevent and/or to avoid occurrence of the particular failure mechanism. Then, the full-chip thermal analysis at the normal operating set of conditions (“Full-Chip Thermal Analysis at Operating Conditions” 110) and subsequent elements of the flow are repeated.

### Temperature Maps

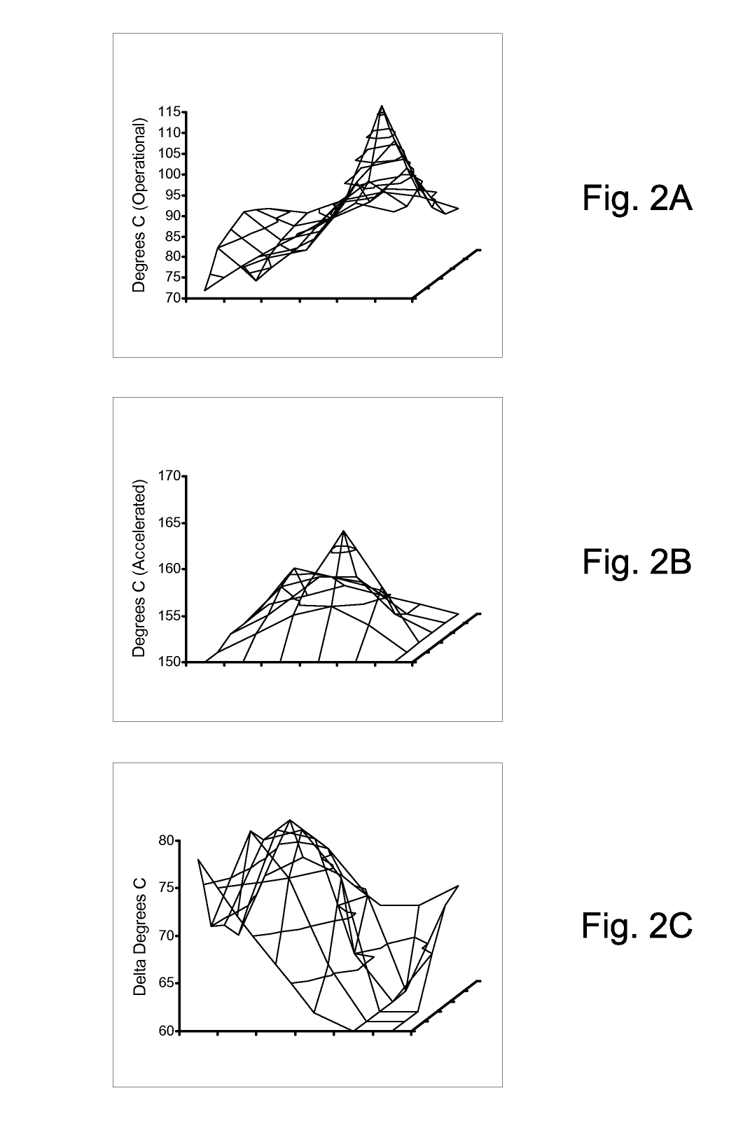

FIGS. 2A and 2B illustrate example temperature maps. The temperature maps of FIGS. 2A and 2B are two-dimensional temperature maps, giving temperature (vertical axis) as a function of location in two dimensions of a semiconductor chip design. The temperature map of FIG. 2A is an example of a temperature map of the semiconductor chip design at normal operating conditions, and the temperature map of FIG. 2B is an example of a temperature map of the semiconductor chip design at accelerated testing conditions. Comparing FIGS. 2A and 2B, it is seen that temperatures and thermal gradients are different, locations of peak temperature are different, and maximum magnitudes of the temperature maps are different.

FIG. 2C illustrates an example differential temperature map (a DT map). FIG. 2C is an example of a difference between temperature maps at different conditions, and is derived from a difference between the temperature map of FIG. 2B (at accelerated testing conditions) and the temperature map of FIG. 2A (at normal operating conditions). As illustrated in FIG. 2C, a location of greatest difference in temperature (a location of maximum magnitude of the DT map) is not the same as either of the locations of peak temperature of the temperature maps of FIGS. 2A and 2B.

### Lc Map

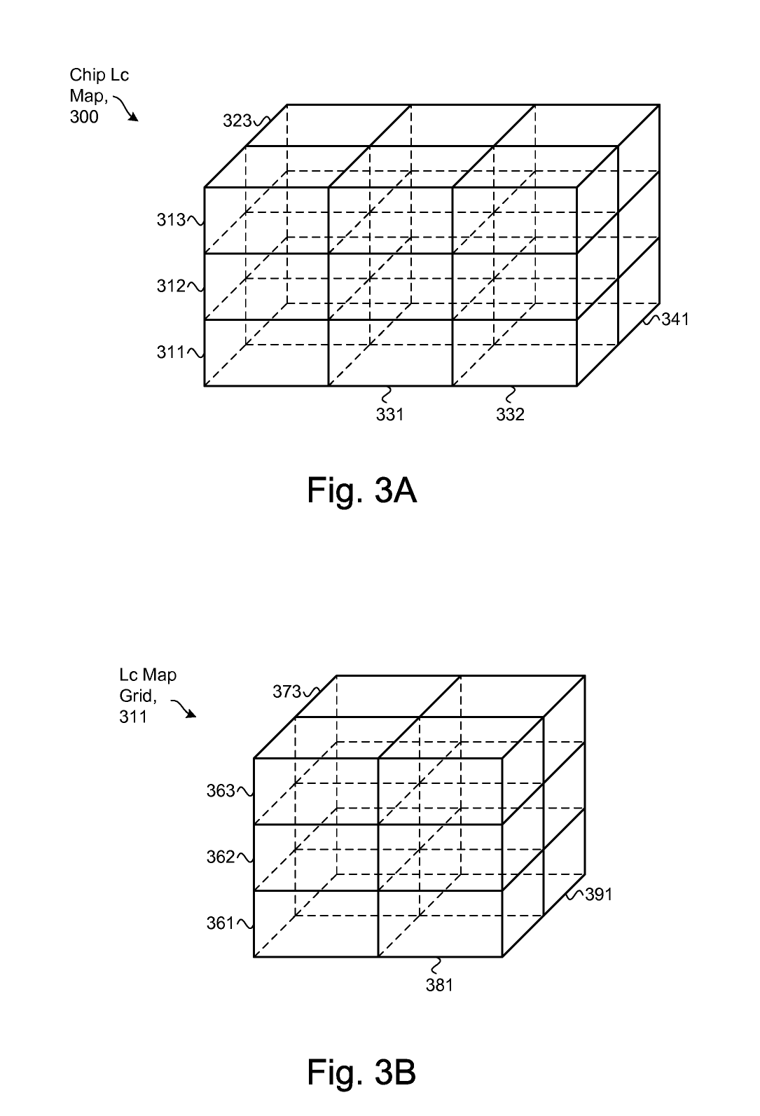

FIGS. 3A and 3B illustrate selected details of a grid of a lifetime acceleration factor map. FIG. 3A illustrates three-dimensional Lc Map 300. Lc Map 300 represents a partitioning of a semiconductor chip design (including, in some embodiments, packaging and/or other associated components) into a three-dimensional set of grids, such as grids 311, 312, 313, 323, 331, 332, and 341. In each grid of the Lc map, a respective lifetime acceleration factor is computed based, at least in part, on temperatures at a respective location of the grid (such as at the center of the grid) at normal operating conditions and at accelerated testing conditions. In some embodiments, the temperatures at the respective locations are interpolated from temperature information in a temperature map at the normal operating conditions and a temperature map at the accelerated testing conditions.

FIG. 3B represents a partitioning of the Lc Map Grid 311, of the three-dimensional Lc Map 300 of FIG. 3A, into a three-dimensional set of sub-grids, such as sub-grids 361, 362, 363, 373, 381, and 391. The sub-grids represent grids of a temperature map, such as a temperature map at the normal operating conditions, contained within the Lc map grid. In some embodiments, partitioned Lc Map Grid 311 contains an integral number of grids of the temperature map. In other embodiments, some or all of the grids of the temperature map are not contained wholly within a single grid of the Lc map.

FIGS. 3A and 3B illustrate grids that are regularly spaced in each dimension. According to various embodiments, gridpoints defining the grids are selected in a variety of ways, such as linear spacing, or based on physical attributes of the semiconductor chip design.

### APPLICABILITY

While the techniques illustrated above have been with respect to semiconductor chips, the techniques are generally applicable to accelerated testing of various components, such as semiconductor chips, electronic parts, electronic components, analog components, packaged versions of any of the foregoing, and in-system versions of any of the foregoing. For example, inclusion of a package and/or of a heatsink changes a type and/or one or more input parameters of a thermal analysis used to produce a temperature map, but does not affect other aspects of the techniques.

### CONCLUSION

Certain choices have been made in the description merely for convenience in preparing the text and drawings and unless there is an indication to the contrary the choices should not be construed per se as conveying additional information regarding structure or operation of the embodiments described. Examples of the choices include: the particular organization or assignment of the designations used for the figure numbering and the particular organization or assignment of the element identifiers (i.e., the callouts or numerical designators) used to identify and reference the features and elements of the embodiments.

The words “includes” or “including” are specifically intended to be construed as abstractions describing logical sets of open-ended scope and are not meant to convey physical containment unless explicitly followed by the word “within.”

Although the foregoing embodiments have been described in some detail for purposes of clarity of description and understanding, the invention is not limited to the details provided. There are many embodiments of the invention. The disclosed embodiments are exemplary and not restrictive.

It will be understood that many variations in construction, arrangement, and use are possible consistent with the description, and are within the scope of the claims of the issued patent. For example, interconnect and function-unit bit-widths, clock speeds, and the type of technology used are variable according to various embodiments in each component block. The names given to interconnect, logic, and sets of testing conditions are merely exemplary, and should not be construed as limiting the concepts described. The order and arrangement of flowchart and flow diagram process, action, and function elements are variable according to various embodiments. Also, unless specifically stated to the contrary, value ranges specified, maximum and minimum values used, or other particular specifications (such as particular statistics and/or distributions used; particular life-stress models used; particular mean time to failure or lifetime acceleration factor equations; particular failure mechanisms analyzed and/or tested; techniques of accelerated life testing; algorithms for full-chip thermal analysis; particular conditions at which full-chip thermal analysis is computed; particular conditions that are measured; and particular parameters that are location, temperature and/or thermal gradient dependent), are merely those of the described embodiments, are expected to track improvements and changes in implementation technology, and should not be construed as limitations.

Functionally equivalent techniques known in the art are employable instead of those described to implement various components, sub-systems, functions, operations, routines, sub-routines, in-line routines, procedures, macros, or portions thereof. It is also understood that many functional aspects of embodiments are realizable selectively in either hardware (i.e., generally dedicated circuitry) or software (i.e., via some manner of programmed controller or processor), as a function of embodiment dependent design constraints and technology trends of faster processing (facilitating migration of functions previously in hardware into software) and higher integration density (facilitating migration of functions previously in software into hardware). Specific variations in various embodiments include, but are not limited to: differences in partitioning; different form factors and configurations; use of different operating systems and other system software; use of different interface standards, network protocols, or communication links; and other variations to be expected when implementing the concepts described herein in accordance with the unique engineering and business constraints of a particular application.

The embodiments have been described with detail and environmental context well beyond that required for a minimal implementation of many aspects of the embodiments described. Those of ordinary skill in the art will recognize that some embodiments omit disclosed components or features without altering the basic cooperation among the remaining elements. It is thus understood that much of the details disclosed are not required to implement various aspects of the embodiments described. To the extent that the remaining elements are distinguishable from the prior art, components and features that are omitted are not limiting on the concepts described herein.

All such variations in design are insubstantial changes over the teachings conveyed by the described embodiments. It is also understood that the embodiments described herein have broad applicability to other applications, and are not limited to the particular application or industry of the described embodiments. The invention is thus to be construed as including all possible modifications and variations encompassed within the scope of the claims of the issued patent.

What is claimed is:

1. A method comprising:
computing, via full-chip thermal analysis at a normal operating set of conditions, a normal operating temperature map of a semiconductor chip design;
computing, via full-chip thermal analysis at a testing set of conditions, a testing temperature map of the semiconductor chip design;
evaluating differences between the testing temperature map and the normal operating temperature map; and
revising the testing set of conditions or changing the semiconductor chip design based, at least in part, on a result of the evaluating.

2. The method of claim 1, further comprising performing accelerated life testing of a portion of a plurality of semiconductor chips embodying the semiconductor chip design.

3. The method of claim 2, wherein the performing is at conditions substantially the same as the testing set of conditions.

4. The method of claim 2, further comprising defining, prior to computing the testing temperature map, the testing set of conditions.

5. The method of claim 4, wherein the defining is based, at least in part, on a specified lifetime acceleration factor of the performing.

6. The method of claim 1, further comprising iterating the computing the normal operating temperature map, the computing the testing temperature map, the evaluating, and the revising or the changing.

7. The method of claim 6, wherein the revising comprises configuring elements of the semiconductor chip design.

8. The method of claim 6, wherein the revising comprises modifying an ambient temperature.

9. The method of claim 6, further comprising selecting one or more of the revising and the changing based, at least in part, on the evaluating.

10. The method of claim 6, wherein the changing comprises changing the location of at least one element of the semiconductor chip design.

11. The method of claim 10, wherein the at least one element is a heating element.

12. The method of claim 10, wherein the at least one element is a wire.

13. The method of claim 6, wherein the changing comprises adding at least one element to the semiconductor chip design.

14. The method of claim 13, wherein the at least one element is a heating element.

15. The method of claim 13, wherein the at least one element is a wire.

16. The method of claim 6, wherein the changing comprises changing a current applied to at least one element of the semiconductor chip design.

17. The method of claim 16, wherein the at least one element is a heating element.

18. The method of claim 16, wherein the at least one element is a wire.

19. The method of claim 1, further comprising iterating the computing the testing temperature map, the evaluating, and the revising.

20. The method of claim 19, further comprising defining, prior to first computing the testing temperature map, the testing set of conditions.

21. The method of claim 20, wherein the defining is based, at least in part, on a specified temperature differential between the normal operating set of conditions and the testing set of conditions.

22. The method of claim 20, wherein the defining is based, at least in part, on a specified lifetime acceleration factor.

23. A method comprising:
computing one or more temperature maps of a semiconductor chip design, wherein the computing is via full-chip thermal analysis at respective sets of conditions;
revising a testing chamber one of the sets of conditions, wherein the revising is based at least in part on a result of the computing and one or more predetermined criteria;
accelerated life testing of a sample of a plurality of semiconductor chips embodying the semiconductor chip design, wherein the accelerated life testing is at accelerated testing conditions including the testing chamber one of the sets of conditions; and
estimating a lifetime of the semiconductor chips based at least in part on a result of the accelerated life testing.

24. The method of claim 23, wherein the sample is 100 or more of the semiconductor chips.

25. The method of claim 23, wherein the result of the accelerated life testing comprises a number of the sample that failed during the accelerated life testing, or are determined to be failed after the accelerated life testing.

26. The method of claim 23, further comprising initially defining the accelerated testing conditions.

27. The method of claim 23, further comprising iterating the computing and the revising.

28. The method of claim 23,
wherein a normal one of the sets of conditions represents normal operating conditions of the semiconductor chips, and the computing is enabled to compute a normal one of the temperature maps at the normal set of conditions; and
further comprising determining the testing chamber set of conditions based, at least in part, on the normal temperature map.

29. The method of claim 28, wherein the determining constructs the testing chamber set of conditions so as to achieve a specified lifetime acceleration factor for the performing.

30. The method of claim 28, wherein the computing is enabled to compute a testing chamber one of the temperature maps at the testing chamber set of conditions.

31. The method of claim 30, wherein the determining constructs the testing chamber set of conditions so as to produce a specified temperature difference between a peak temperature of the normal temperature map and a peak temperature of the testing chamber temperature map.

32. The method of claim 30, wherein the determining constructs the testing chamber set of conditions so as to produce a specified temperature difference between a peak temperature of the normal temperature map and a temperature at a corresponding location of the testing chamber temperature map.

33. The method of claim 30, wherein the determining constructs the testing chamber set of conditions so as to produce a specified temperature difference between a peak temperature of the testing chamber temperature map and a temperature at a corresponding location of the normal temperature map.

34. The method of claim 30, wherein the determining constructs the testing chamber set of conditions to ensure that a maximum temperature of the testing chamber temperature map is less than a specified amount.

35. The method of claim 30, wherein the determining constructs the testing chamber set of conditions to ensure that at each of a plurality of locations, a value of the testing chamber temperature map corresponding to the each location is less than a respective specified maximum temperature of the each location.

36. The method of claim 23, further comprising measuring at least some conditions during the accelerated life testing.

37. The method of claim 36, further comprising:
wherein an accelerated testing one of the sets of conditions comprises the measured conditions, and the computing is enabled to compute an accelerated testing one of the temperature maps at the accelerated testing set of conditions;
wherein a normal one of the sets of conditions represents normal operating conditions of the semiconductor chips, and the computing is enabled to compute a normal one of the temperature maps at the normal set of condition; and
evaluating differences between the accelerated testing temperature map and the normal temperature map.

38. The method of claim 37, wherein the estimating is further based, at least in part, on a result of the evaluating.

39. A method comprising:
computing, via full-chip thermal analysis, a first temperature map of a semiconductor chip design at a first set of conditions;
computing, via full-chip thermal analysis, a second temperature map of the semiconductor chip design at a second set of conditions;
determining, using at least in part the first temperature map and the second temperature map, a lifetime acceleration factor map; and
estimating a lifetime of semiconductor chips embodying the semiconductor chip design based, at least in part, on the lifetime acceleration factor map.

40. The method of claim 39, wherein the determining is according to a thermal gradient aware lifetime acceleration factor equation.

41. The method of claim 40, wherein the thermal gradient aware lifetime acceleration factor equation comprises a temperature-aware current density term.

42. The method of claim 40, wherein the thermal gradient aware lifetime acceleration factor equation comprises a so-called current constant dependent on thermal gradients.

43. The method of claim 39, further comprising performing accelerated life testing of a plurality of the semiconductor chips.

44. The method of claim 43, wherein the performing is at conditions substantially the same as the second set of conditions.
